(19) United States
(12) Patent Application Publication
(10) Pub. No.: US 2017/0359221 A1
(43) Pub. Date: Dec. 14, 2017

(54) METHOD AND MANAGEMENT SYSTEM FOR CALCULATING BILLING AMOUNT IN RELATION TO DATA VOLUME REDUCTION FUNCTION

(71) Applicant: Hitachi, Ltd., Tokyo (JP)

(72) Inventors: Koichi HORI, Tokyo (JP); Akira NISHIMOTO, Tokyo (JP); Futoshi HAGA, Tokyo (JP)

(73) Assignee: Hitachi, Ltd., Tokyo (JP)

(21) Appl. No.: 15/539,212

(22) PCT Filed: Apr. 10, 2015
(86) PCT No.: PCT/JP2015/061227

§ 371 Date: Jun. 23, 2017

(51) Int. Cl. H04L 12/24; G06F 3/06; G06Q 50/10

(52) U.S. Cl. CPC H04L 41/0896; G06F 3/0665; G06Q 50/10

(57) ABSTRACT

A logical volume (VOL) is provided from a storage system to a host system of a service user. A data volume reduction process is applied to data stored in the VOL. A management system determines whether at least one of a provided total capacity (provided to the service users) and a user used total volume (prior to the data volume reduction process) exceeds a storage volume capacity (upper limit of capacity of a storage space for the service provider). If so, a billing amount is calculated based on at least one amount among a first excess capacity (the difference between the user used total volume and the storage volume), a second excess capacity (the difference between the provided total capacity and the storage volume), and an amount corresponding to the service user defined as relating to at least one of the first excess capacity and the second excess capacity.

### TECHNICAL FIELD

The present invention generally relates to a computer technique for calculating a billing amount.

### BACKGROUND ART

In recent years, a data volume stored in a storage system has been steadily increasing. A storage apparatus purchased or rent from a storage vendor by a service provider (e.g., a service provider of a cloud service) includes a storage space in which data is stored. In the following explanation, the storage space is referred to as “assigned space” and a capacity of the assigned space (an upper limit of a capacity of the storage space in which the data is stored) is referred to as “storage volume”. A storage space (e.g., a logical volume) based on the assigned space is provided to a host system of a service user as a service of the service provider (or in order to enable use of the service). A host system transmits a write request designating the provided storage space. Data conforming to the write request is stored in the assigned space on which the designated storage space is based.

The assigned space is a space based on a storage device such as a HDD (Hard Disk Drive) or an SSD (Solid State Drive). The service provider needs to continue to increase the storage volume by, for example, purchasing the storage device such as the HDD or the SSD. Therefore, cost for purchasing the storage device is a large burden for the service provider.

Therefore, a data volume reduction function such as compression or de-duplication attracts attention (e.g., PTL 1).

### CITATION LIST

### Patent Literature

[PTL 1] U.S. Pat. No. 8,161,211

### SUMMARY OF INVENTION

### Technical Problem

However, a data volume that can be reduced by the data volume reduction function is not uniform because the data volume depends on a data attribute (e.g., a data pattern). Therefore, a data volume reduction effect could be low (a reduced data volume could be small).

Even if an idle capacity in the storage volume increases because the data volume is reduced, the idle capacity could be not used. Therefore, it is not always considered desirable to determine a billing amount on the basis of an increased idle capacity.

In these cases, it is difficult to find an advantage for the service provider with respect to a price of the data volume reduction function.

Even if a computer is introduced, it is difficult to reasonably bill the service provider in relation to the data volume reduction function. This is because, as explained above, the data volume that can be reduced by the data volume reduction function is still not uniform.

### Solution to Problem

In this specification, “reasonably billing a service provider” means billing that is considered appropriate at least for the service provider. As a viewpoint of the reasonable billing, the reasonable billing does not always need to be a level of a billing amount. Instead of or in addition to the level of the billing amount, there is at least one of timing of the billing and a calculation ground for the billing amount. Processing explained below is performed in an environment in which a logical volume is provided from a storage system to a host system of a service user and a data volume reduction process is applied to data stored in the logical volume by a data volume reduction function. That is, a management system or a storage system determines whether at least one of a provided total capacity (the total capacity of one or more logical volumes provided to one or more service users) and a user used total volume (the total volume of one or more pieces of data prior to the data volume reduction process stored in the one or more logical volumes) exceeds a storage volume (the upper limit of the capacity of a storage space that the storage system holds for the service provider and in which the data is stored). If a result of the determination is affirmative, the management system or the storage system calculates a billing amount based on at least one amount among a first excess capacity (the difference between the user used total volume and the storage volume), a second excess capacity (the difference between the provided total capacity and the storage volume), and an amount corresponding to the service user defined as relating to at least one of the first excess capacity and the second excess capacity.

### Advantageous Effects of Invention

It is possible to calculate a billing amount reasonable for the service provider in relation to the data volume reduction function.

### BRIEF DESCRIPTION OF DRAWINGS

FIG. 1 shows an example of an overview of an information system according to an embodiment.

FIG. 2 shows an example of an overview of the embodiment.

FIG. 3 shows a first portion of a specific example of the embodiment.

FIG. 4 shows a second portion of the specific example of the embodiment.

FIG. 5 shows a third portion of the specific example of the embodiment.

FIG. 6 shows an example of a hardware configuration of the information system according to the embodiment.

FIG. 7 shows an example of programs and information stored by a shared memory in a physical storage apparatus.

FIG. 8 shows an example of programs and information stored by a memory in a management system.

FIG. 9 shows an example of the configuration of a service management table.

FIG. 10 shows an example of a flow including an operation start and periodical data collection after the operation start.

FIG. 11 shows an example of a lending volume addition GUI.

FIG. 12 shows an example of a lending volume addition flow.

FIG. 13 shows an example of an overview of a threshold check flow.

FIG. 14 shows an example of details of the threshold check flow.

FIG. 15 shows another example of the details of the threshold check flow.

FIG. 16 shows an example of an addition/migration GUI.

FIG. 17 shows an example of a compression GUI.

FIG. 18 shows billing of an excess capacity amount in addition to actual-use amount after the capacity is exceeded.

FIG. 19 shows a first portion of an example of a billing amount calculation flow.

FIG. 20 shows a second portion (in the case in which a base of the excess capacity amount is a user used total volume ΣU_{U}) of the example of the billing amount calculation flow.

FIG. 21 shows a third portion (in the case in which the base of the excess capacity amount is a lending total volume ΣU_{T}) of the example of the billing amount calculation flow.

FIG. 22 shows a first example of a calculation result GUI.

FIG. 23 shows an example of arrangement according to contract order of user used volumes (or lending volumes) in the case in which contract cancellation (or addition of a new service user) occurs.

FIG. 24 shows a second example of the calculation result GUI.

FIG. 25 shows an example of a plurality of patterns of an arrangement of user used volumes (or lending volumes) in the case in which contract cancellation (or addition of a new service user) occurs.

FIG. 26 shows a third example of the calculation result GUI.

FIG. 27 shows an example of each of a plurality of user lists respectively corresponding to the plurality of patterns.

FIG. 28 shows an example of billing target determination involved in an increase or a decrease in a used volume U_{U} of a contracting service user.

FIG. 29 shows an explanatory diagram of an example of a reason why ΣU_{T} is not adopted as a base of an excess capacity amount concerning a VVOL (virtual volume).

FIG. 30 is an explanatory diagram of an example of a reason why ΣU_{U} is adopted as the base of the excess capacity amount concerning the VVOL.

### DESCRIPTION OF EMBODIMENTS

An embodiment is explained below.

In the following explanation, information is explained with an expression “X×X table”. However, the information may be represented by any data structure. That is, the “X×X table” can be referred to as “XXX information” in order to indicate that the information does not depend on a data structure. In the following explanation, the configurations of tables are examples. One table may be divided into two or more tables. All or a part of two or more tables may be one table.

In the following explanation, an ID or a name is used as identification information of an element. Other kinds of identification information may be used instead of or in addition to the ID or the name.

In the following explanation, when elements of the same type are explained without being distinguished, reference signs or reference signs with a common number are used. When elements of the same type are distinguished and explained, reference signs of the elements are used or IDs allocated to the elements are used instead of the reference signs.

In the following explanation, an I/O (Input/Output) request may be a write request or a read request and may be referred to as access request.

In the following explanation, a “storing unit” may be one or more storage devices including memories. For example, of a main storage device (typically, a volatile memory) and an auxiliary storage device (typically, a nonvolatile storage device), the storing unit may be at least the main storage device. The storing unit may include at least one of a cache area (e.g., a cache memory or a part of an area of the cache memory) and a buffer area (e.g., a buffer memory or a part of an area of the buffer memory).

In the following explanation, a “PDEV” may indicate a physical storage device and may be typically a nonvolatile storage device (e.g., an auxiliary storage device). The PDEV may be, for example, a HDD (Hard Disk Drive) or an SSD (Solid State Drive).

In the following explanation, “RAID” is an abbreviation of Redundant Array of Independent (or Inexpensive) Disks. A RAID group is configured by a plurality of PDEVs and stores data according to a RAID level associated with the RAID group. The RAID group may be referred to as parity group. The parity group may be, for example, a RAID group that stores parity.

In the following explanation, processing is explained using a “program” as a subject. However, the program is executed by a processor (e.g., a CPU (Central Processing Unit)) to perform decided processing using a storing unit (e.g., a memory) and/or an interface device (e.g., a communication port) or the like as appropriate. Therefore, the subject of the processing may be the processor. The processing explained using the program as the subject may be processing performed by a processor or an apparatus or a system including the processor. The processor may include a hardware circuit that performs a part of or the entire processing. The program may be installed in an apparatus such as a computer from a program source. The program source may be, for example, a storage medium readable by a program distribution server or a computer. When the program source is the program distribution server, the program distribution server may include a processor (e.g., a CPU) and a storing unit. The storing unit may further store a distribution program and a distribution target program. The processor of the program distribution server may execute the distribution program to distribute the distribution target program to other computers. In the following explanation, two or more programs may be realized as one program or one program may be realized as two or more programs.

In the following explanation, a management system may be configured by one or more computers. Specifically, for example, when a management computer displays information (specifically, for example, when the management computer displays information on a display device of the management computer or the management computer transmits information for display to a remote computer for display), the management computer is a management system. For example, when a function equivalent to a function of the management computer is realized by a plurality of computers, the plurality of computers (which may include the computer for display when the computer for display is responsible for display) are the management system. The management computer (e.g., the management system) may include an interface device coupled to an I/O system including a display system, a storing unit (e.g., a memory), and a processor coupled to the interface device and the storing unit. The display system may be a display device included in the management computer or may be the computer for display coupled to the management computer. The I/O system may be an I/O device (e.g., a keyboard and a pointing device or a touch panel) included in the management computer or may be the computer for display or another computer coupled to the management computer. The management computer “displaying information for display” may be displaying the information for display on the display system. This may be displaying the information for display on the display device included in the management computer or may be the management computer transmitting the information for display to the computer for display (in the latter case, the information for display is displayed by the computer for display). Inputting and outputting information by the management computer may refer to inputting and outputting information between the management computer and the I/O device included in the management computer or to inputting and outputting information between the management computer and a remote computer (e.g., the computer for display) coupled to the management computer. The output of information may be display of information.

In the following explanation, “VOL” is an abbreviation of logical volume. A VOL provided to a service user may be either one of a real VOL (RVOL) and a virtual VOL (VVOL). However, in this embodiment, a storage system can provide both of the RVOL and the VVOL. The “RVOL” is a VOL based on a physical storing unit (e.g., one or more RAID groups) included in a storage system including the RVOL. Typically, the “VVOL” is a capacity expanded VOL (TPVOL). The TPVOL is a VOL configured by a plurality of virtual areas (virtual storage areas) and conforming to a capacity virtualization technique (typically, Thin Provisioning). When a storage controller 21 receives a write request from a host computer, if a real area (a substantive storage area) is not allocated to a virtual area (a virtual area of the VVOL (the TPVOL)) to which an address designated by the write request belongs, the storage controller 21 allocates the real area to the virtual area from a pool and writes write target data incidental to the write request in the allocated real area. The “pool” may be a storage area configured by a plurality of real areas. Specifically, for example, the pool may be a set of one or more pool VOLs. The “pool VOL” may be a VOL serving as a component of the pool. The pool VOL may be a VOL (RVOL) based on the RAID group or may be a virtual VOL based on a storage resource (e.g., a VOL) of an external storage device.

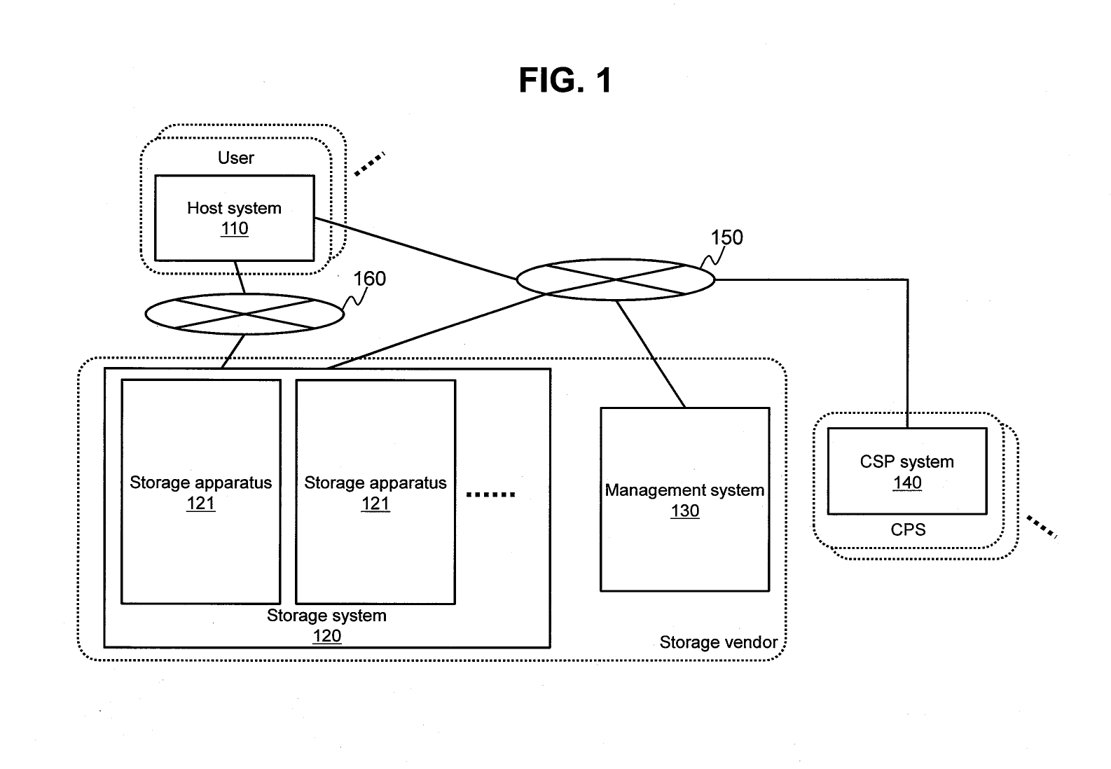

FIG. 1 shows an example of an overview of an information system according to an embodiment.

In this embodiment, a storage vendor, a plurality of (or one) cloud service providers (hereinafter, CSPs), and a plurality of (or one) service users are present. One or more service users are present per one CSP. The CSP is an example of a service provider.

The storage vendor is an entity that provides (or sells or lends) storage apparatuses 121 (or storage capacities) to the CSPs and provides storage spaces (e.g., VOLs) having capacities designated from the CSPs (or the service users) to the service users. The storage vendor manages a storage system 120 and a management system 130. The storage system 120 may be a system manufactured by the storage vendor or sold, lent, or use-permitted to the CSPs by the storage vendor. The storage system 120 may be coupled to a first communication network (e.g., a SAN (Storage Area Network) or a WAN (Wide Area Network)) 160 and a second communication network (e.g., an IP (Internet Protocol) network such as the Internet) 150. One communication network may be adopted instead of the first and second communication networks 150 and 160. The storage system 120 includes a plurality of (or one) storage apparatus 121. The storage apparatus 121 may be a unit provided (e.g., sold or lent) to the CSPs. The plurality of storage apparatuses 121 may be a plurality of physical storage apparatuses, may be a plurality of virtual storage apparatus, or may be a mixture of one or more physical storage apparatuses and one or more virtual storage apparatuses. The virtual storage device may be a storage LPAR (Logical Partitioning) to which resources of the physical storage apparatus are allocated. In this embodiment, one storage apparatus 121 is not shared by a plurality of CSPs. However, the storage apparatus is not limited to this. The management system 130 may be coupled to a second communication network 150 and may include a computer of a storage manager.

The CSP is an entity that provides a cloud service for purchasing (renting) the storage apparatus 121 (or the storage capacity) from the storage vendor and lending (or selling) a capacity (typically, a VOL) to a contracting service user. A storage space having a capacity requested from the service user is provided to a host system 110 of the service user from the purchased storage apparatus 121. The storage apparatus 121 purchased (rented) by the CSP includes a storage space in which data is stored. In this embodiment, the storage space is referred to as “assigned space” and a capacity of the assigned space (the upper limit of a capacity of the storage space in which data is stored) is referred to as “storage volume”. The CPU manages a CSP system 140. The CSP system 140 is a computer system of the CSP (e.g., a computer managed by the CSP) and is an example of a provider system. The CSP system 140 may be coupled to the second communication network 150. The CSP system 140 may include one or more computers. The one or more computers may include a server that provides a cloud service and a computer of a CSP manager that manages the server. The CSP system 140 communicates with at least the management system 130 among the storage system 120, the management system 130, and the host system 110.

The service user is an entity that receives a cloud service from the CSP (i.e., rents (or purchases) a capacity from the CSP). The service user manages the host system 110. The host system 110 receives, from the storage system 120, provision of a storage space having a capacity rented from the CSP by the service user. The storage space is, for example, a VOL like a file system space. The host system 110 transmits an I/O request designating the provided storage space. The host system 110 may include one or more computers. The one or more computers may include a server that transmits an I/O request designating the provided storage space and a computer of a user manager who manages the server.

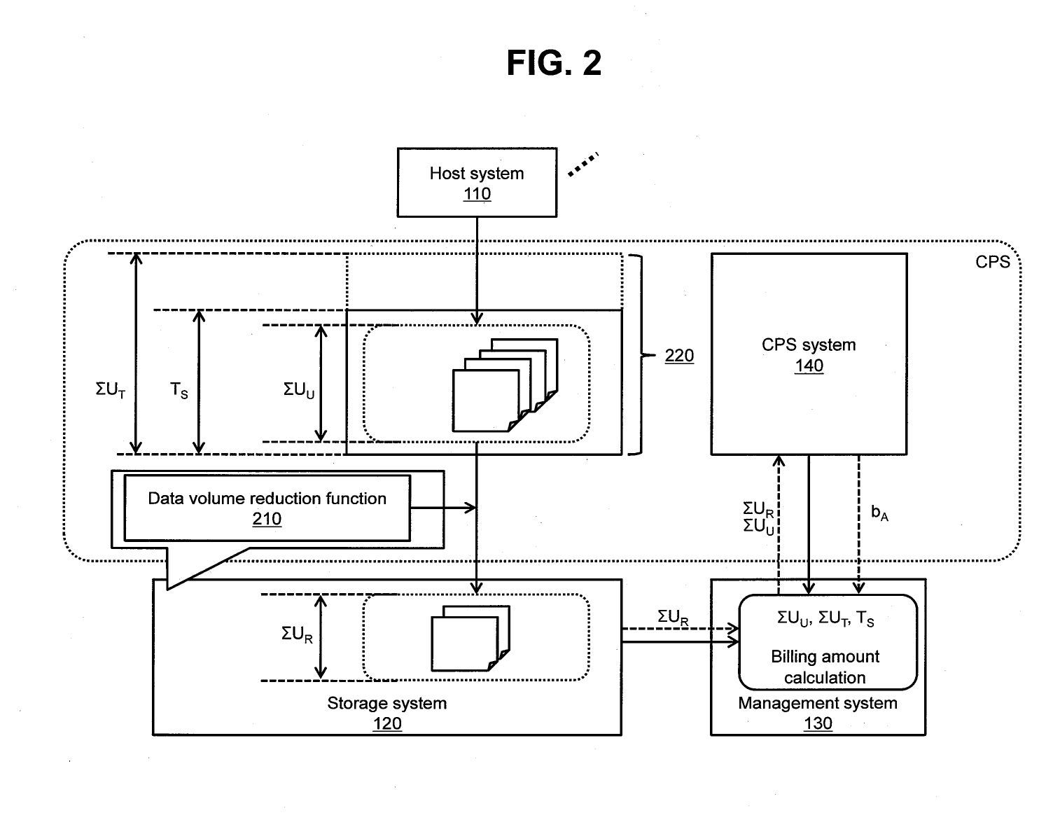

FIG. 2 shows an example of an overview of the embodiment.

In this embodiment, the storage apparatus 121 includes a data volume reduction function 210. For example, the CSP purchases or rents the storage apparatus 121 (or purchases or rents the data volume reduction function 210 as an option), whereby a data volume reduction process by the data volume reduction function 210 is applied to data conforming to a write request designating a storage space having a capacity lent to the service user by the CSP.

As explained above, even if a computer is introduced, it is difficult to reasonably bill the service provider in relation to the data volume reduction function 210. This is because, as explained above, the data volume that can be reduced by the data volume reduction function 210 is still not uniform.

Therefore, in this embodiment, an interface that receives, from at least one of the CSP system 140 and the storage system 120, first information for identifying at least one of a user used total volume (ΣU_{U}) and a lending total volume (ΣU_{T}) and second information for identifying a storage volume (T_{S}) is provided in the management system 130 capable of communicating with the CSP system 140 and the storage system 120. ΣU_{U} is a total volume of one or more user used volumes (Uₙ) respectively corresponding to one or more service users. U_{U} corresponding to a service user is a volume of one or more pieces of data before the data volume reduction process and is a volume of one or more pieces of data written in a storage space from the host system 110 of the service user. ΣU_{T} is a total volume of one or more lending volumes (U_{T}) respectively corresponding to one or more service users. The lending total volume (ΣU_{T}) is an example of a provided total capacity. The lending volume (U_{T}) is an example of a provided capacity. U_{T} corresponding to a service user is a capacity lent to the service user (a capacity of a storage space provided to the host system 110 of the service user). The first information may be at least one of ΣU_{U} and ΣU_{T} (e.g., at least one of ΣU_{U} and ΣU_{T} calculated by the storage system 120) or may be an element necessary for calculation of at least one of ΣU_{U} and ΣU_{T} (e.g., a difference from a value received last time or at least one of U_{U} and U_{T} for each service user). The second information may be T_{S} or may be an element necessary for calculation of T_{S} (e.g., a difference from a value received last time).

The management system 130 determines, using the received information, whether at least one of ΣU_{U} and ΣU_{T} exceeds T_{S}. If a result of the determination is affirmative, the management system 130 calculates a billing amount taking into account an excess capacity amount, which is an amount based on at least one of a first excess capacity (ΣU_{U}−T_{S}), which is a difference between ΣU_{U} and T_{S}, and a second excess capacity (ΣU_{T}−T_{S}), which is a difference between ΣU_{T} and T_{S}. The “billing amount taking into account the excess capacity amount” may be the excess capacity amount itself or may be a billing amount including the excess capacity amount and some other amount.

The CSP performs business for entering into a contract with the service user and lending a capacity to the service user to receive a consideration from the service user (note that this business form is an example and a form other than the lending of the capacity such as sale of the capacity may be adopted). Since a volume of data stored in the storage apparatus 121 can be reduced by the data volume reduction function 210, ΣU_{U} may exceed T_{S}. Therefore, the CSP can perform capacity lending in which ΣU_{T} exceeds T_{S}. That is, as shown in FIG. 2, the total capacity ΣU_{T} of a set 220 of one or more storage spaces (typically, VOLs) lent to one or more service users may exceed T_{S}. In this way, the CSP can increase a capacity lent to an existing service user and lend a capacity to a new service user without increasing T_{S}. As a result, it is possible to increase a profit of the CSP.

From such a viewpoint, as explained above, the management system 130 associates excess of T_{S} by at least one of ΣU_{U} and ΣU_{T} as a data volume reduction effect (an effect of the data volume reduction function 210) and a profit obtained by the CSP. The management system 130 calculates a billing amount including an excess capacity amount, which is an amount based on at least one of (ΣU_{U}-T_{S}) and (ΣU_{T}−T_{S}).

Consequently, when the CSP enjoys a benefit of the data volume reduction function 210, the CSP only has to pay an amount calculated on the basis of the benefit to the storage vendor as a consideration of the data volume reduction function 210. That is, it is possible to realize reasonable billing for the CSP in relation to the data volume reduction function 210. It can be expected that the storage vendor continuously obtains an income not only when the storage apparatus 121 is purchased but also during the operation of the storage apparatus 121.

Note that, as a comparative example in which a reasonable billing amount is calculated, it is conceivable to set a data volume reduction effect (reduction ratio) as a base of a billing amount. However, it is likely that a data pattern (or another data attribute) changes when data is updated and, as a result, the data volume reduction effect changes. Then, it is difficult to determine at which timing the data volume reduction effect adopted as the base of the billing amount should be determined. Therefore, a billing amount calculating method according to this embodiment is considered to be more effective.

Reasonably billing the CSP in relation to the data volume reduction function 210 leads to expectation of promotion of the use of the data volume reduction function 210. Reasonably billing in relation to the data volume reduction function 210 is, in one viewpoint, improvement of a technique for evaluating a function. The promotion of the use of the data volume reduction function 210 is, in one viewpoint, promotion of cloud service provision or resource saving because a more capacity can be lent in the same storage volume (a more pieces of data volume can be stored). Therefore, according to this embodiment, it can be expected that another technique of the cloud service provision or the resource saving can be improved through improvement of a function evaluation technique.

Note that, there are several variations for timing for billing and a target serving as a ground for calculation of a billing amount. The variations will be explained below.

The assigned space having the storage volume T_{S} is, for example, a logical storage space based on one or more PDEVs (typically, RAID groups). A VOL based on the logical storage space is provided to the host system 110. The logical storage space is managed as a pool and a VVOL associated with the pool is provided to the host system 110. Since capacity lending exceeding T_{S} is possible, although an idle capacity is left from the viewpoint of the service user, it could occur that data cannot be stored anew (e.g., an actual used total volume (ΣU_{R}) reaches the storage volume T_{S}) (note that ΣU_{R} is a total volume of one or more actual used volume (U_{R}) respectively corresponding to one or more service users. U_{R} corresponding to a service user is a volume of one or more pieces of data that have been subjected to the data volume reduction and actually written in the storage system 120). For the CSP, it is a problem that the service user cannot write data. Since the CSP is based on the premise that the CSP lends a capacity to the service user, the CSP has a larger responsibility in guaranteeing the service user that data can be written than using the storage apparatus 121 for the CSP itself. Therefore, it is difficult for the CSP to determine to which degree ΣU_{T} (or ΣU_{U}) may exceed T_{S}. Therefore, lending in which ΣU_{T} (or ΣU_{U}) exceeds T_{S} is not actively performed. As a result, an advantage of the data volume reduction function 210 could not be sufficiently achieved.

Therefore, in this embodiment, in order to prevent ΣU_{R} from reaching T_{S}, one or more thresholds are provided concerning ΣU_{R} and a threshold check function and a threshold countermeasure function based on one or more thresholds are also provided. Since there are such thresholds, the CSP can perform, at ease, capacity lending in which ΣU_{T} (or ΣU_{U}) exceeds T_{S}. Consequently, as an advantage of the data volume reduction function 210, it is possible to increase a profit (an amount obtained from the service user) obtained by the CSP. It is possible to reasonably bill the CSP. The threshold check function and the threshold countermeasure function are also explained below.

In this embodiment, the interface provided in the management system 130 can perform at least one of reception of third information for identifying ΣU_{R} from the storage system 120 and provision of the third information (or ΣU_{R} identified from the third information) to the CSP system 140. The third information may be ΣU_{R} (e.g., ΣU_{R} calculated by the storage system 120) or may be an element necessary for calculation of ΣU_{R} (e.g., a difference from a value received last time or U_{R} for each service user). ΣU_{R} and ΣU_{U} (or a data volume reduction effect calculated on the basis of ΣU_{R} and ΣU_{U}) are displayed on the CSP system 140 (the display device included in the CSP system 140). Consequently, the CSP manager can easily determine an additional volume b_{A} (a capacity including at least one of a capacity added to a lending volume to the existing service user and a lending volume to a new service user) from the data volume reduction effect based on ΣU_{R} and ΣU_{U}. The interface of the management system 130 may receive the additional volume b_{A} determined by the CSP manager from the CSP system 140. The management system 130 can determine a billing amount on the basis of the received additional amount b_{A}.

The functions of the management system 130 may be provided concentratedly in at least one system other than the management system 130 or may be provided distributedly. For example, when the functions of the management system 130 are provided in the storage system 120, the CSP system 140 and the storage system 120 may be communicably coupled. At least one of T_{S}, ΣU_{T}, ΣU_{U}, and ΣU_{R} may be calculated in any one of the storage system 120, the management system 130, and the CSP system 140. For example, the management system 130 may periodically receive T_{S} (or a difference from a value received last time) and a value set (U_{T}, U_{U}, and U_{R}) for each service user and calculate each of T_{S}, ΣU_{T}, ΣU_{U}, and ΣU_{R} using the received information. Alternatively, the management system 130 may periodically receive each of T_{S}, ΣU_{T}, ΣU_{U}, and ΣU_{R} from at least one of the storage system 120 and the CSP system 140 and store each of the received T_{S}, ΣU_{T}, ΣU_{U}, and ΣU_{R}. In the following explanation, in order to facilitate understanding of the explanation, it is assumed that the management system 130 receives T_{S} itself from the storage system 120 (or the CSP system 140) as information for identifying T_{S}. It is assumed that the management system 130 receives ΣU_{T} itself and one or more lending volumes (U_{T}) respectively corresponding to one or more service users from the storage system 120 (or the CSP system 140) as information for identifying ΣU_{T}. It is assumed that the management system 130 receives ΣU_{U} itself and one or more user used volumes (Uₙ) respectively corresponding to one or more service users from the storage system 120 as information for identifying ΣU_{U}. It is assumed that the management system 130 receives ΣU_{R} itself and one or more actual used volumes (U_{R}) respectively corresponding to one or more service users from the storage system 120 as information for identifying ΣU_{R}.

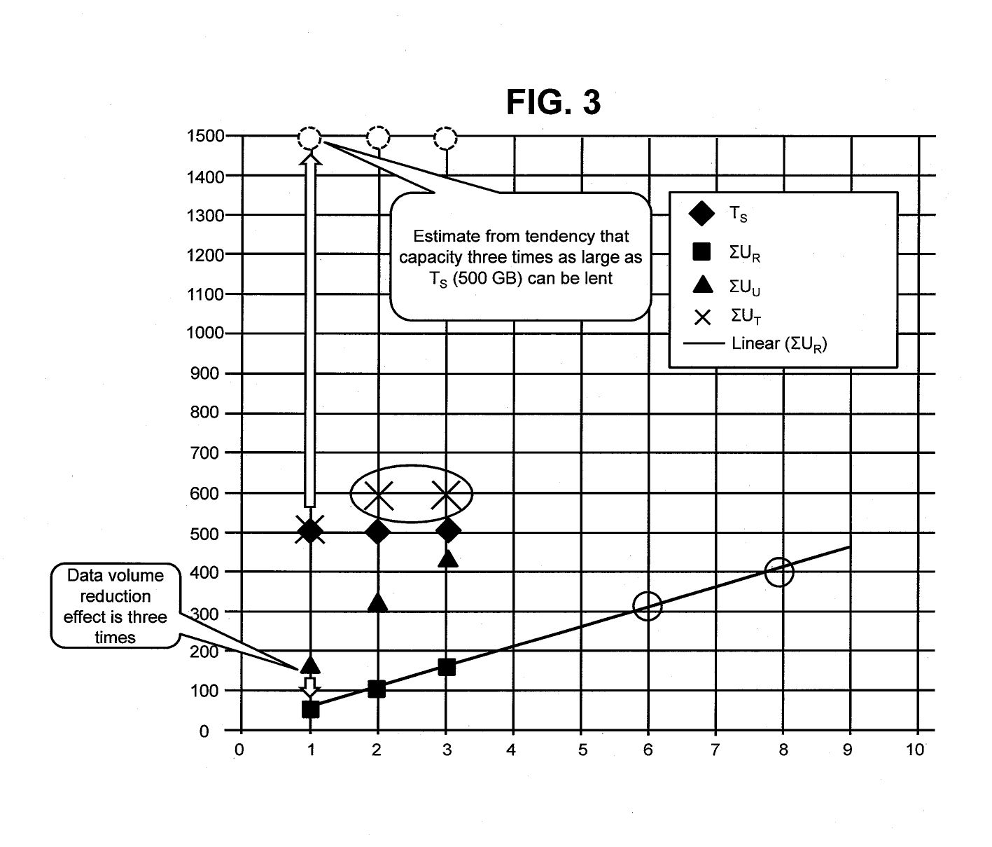

A specific example of the embodiment is explained with reference to FIG. 3 to FIG. 5. Note that, in graphs of FIG. 3 to FIG. 5, the horizontal axis indicates a reference date (e.g., an elapsed time (e.g., a unit is “month”) from a contract date of the CSP and the storage vendor) and the vertical axis indicates a capacity (e.g., a unit is “GB (gigabyte)”. Information including the graphs of FIG. 3 to FIG. 5 may be displayed on the CSP system 140 by the management system 130. The information may include an input UI (user interface) of a lending volume to the service user.

According to FIG. 3, in a first month, T_{S}=ΣU_{T}=500 GB. That is, the entire TS is lent to one or more service users. ΣU_{U}=150 GB and ΣU_{R}=50 GB. That is, ΣU_{R} is ⅓ of ΣU_{U}. Therefore, the data volume reduction effect is three times. Therefore, the CSP manager can provisionally calculate 1500 GB, which is a capacity three times as large as TS, as an upper limit of ΣU_{T}.

In a second month, the CSP manager lent a capacity of 100 GB to a new service user. Therefore, ΣU_{T}=500 GB+100 GB=600 GB. ΣU_{T} exceeded T_{S}. Even if one service user is added, the data volume reduction effect remains three times as large as T_{S}. According to transition of ΣU_{R} up to a third month, the CSP manager can provisionally estimate that ΣU_{R} is 60% of T_{S} in a sixth month and is 80% of T_{S} in an eighth month. Note that, in this specific example, it is assumed that a first threshold Th1 and a second threshold Th2 are configured in the management system 130 as thresholds concerning ΣU_{R}. Th1<Th2. In this embodiment, each of Th1 and Th2 is a ratio to T_{S}. In this specific example, it is assumed that Th1 is 60% of T_{S} and Th2 is 80% of T_{S}.

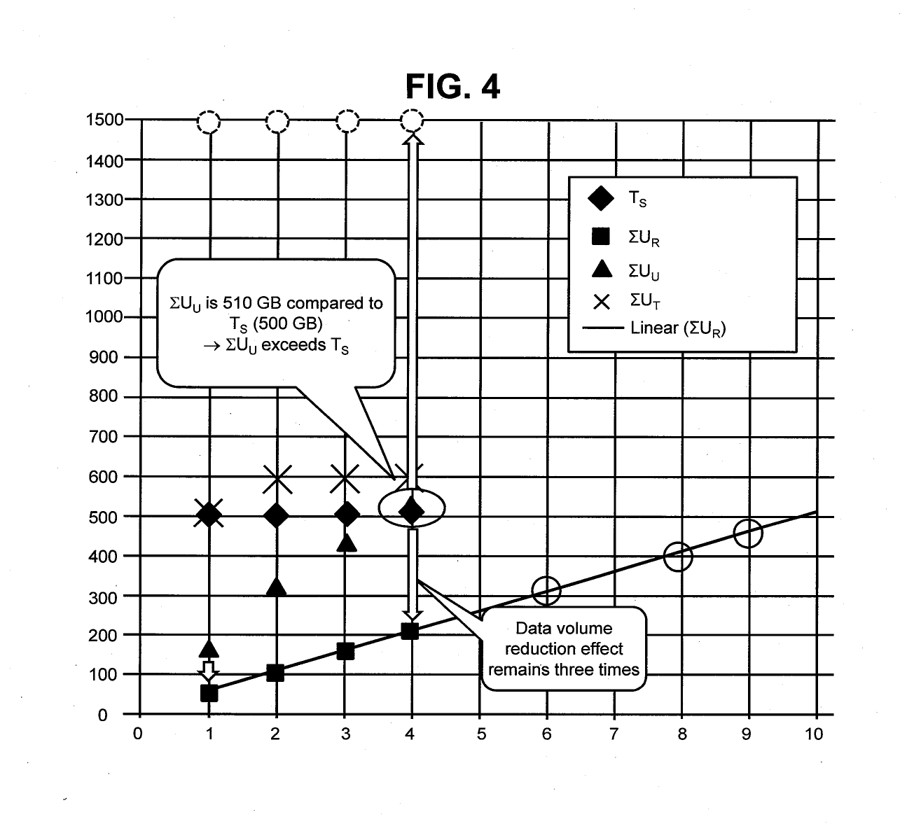

According to FIG. 4, in a fourth month, ΣU_{R} was smaller than T_{S} because of the data volume reduction effect (three times). However, ΣU_{U} was 510 GB and exceeded T_{S} (500 GB). This excess was regarded as a business expansion (a profit) of the CSP. A billing amount based on the excess was calculated by the management system 130.

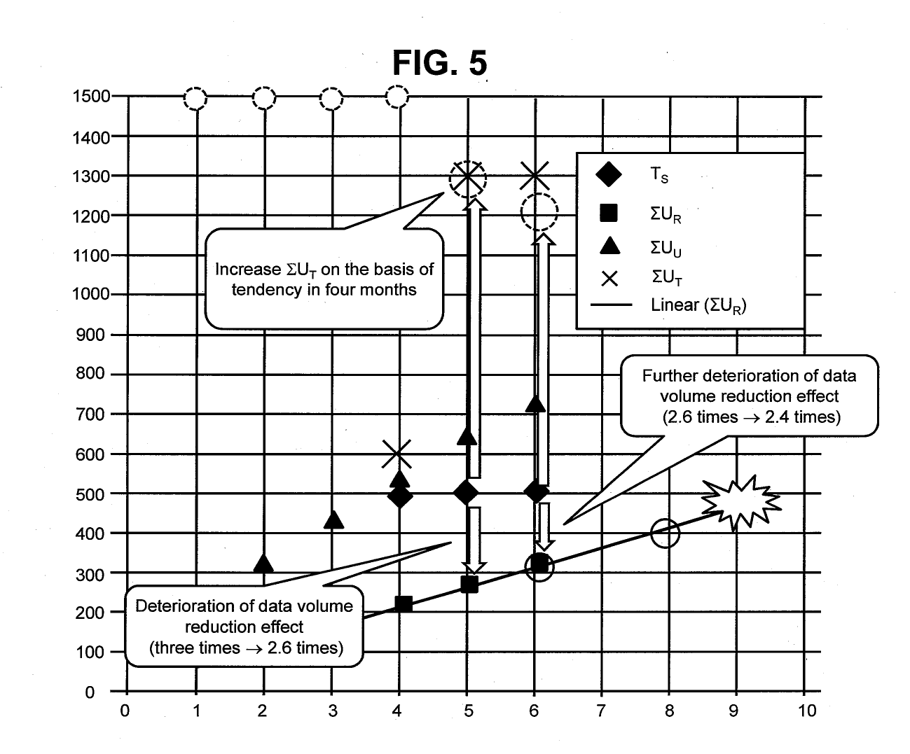

According to FIG. 5, in a fifth month, ΣU_{T} was expanded to 1300 GB from a tendency in the four months. On the other hand, the data volume reduction effect decreased to 2.6 times. Therefore, TS(500 GB)*data volume reduction effect (2.6)=1300 GB. Since ΣU_{T} is 1300 GB, it is likely that capacity depletion occurs (ΣU_{R} reaches 500 GB (T_{S}) before ΣU_{U} reaches 1300 GB).

In a sixth month, the data reduction effect was further deteriorated (decreased to 2.4 times). Therefore, the upper limit of ΣU_{U} is 1200 GB with respect to T_{S} (500 GB). This is smaller than ΣU_{T} (1300 GB). Therefore, the likelihood of the capacity depletion further increased. From a tendency in the two months, an actual use ratio (a ratio of ΣU_{R} to T_{S}) reached Th1 (60% of TS). In future two months, the actual use ratio is provisionally estimated as reaching Th2 (80% of T_{S}). Therefore, the CSP manager can determine that some countermeasures for securing an idle capacity (a writable capacity) are necessary.

According to the specific example explained above, the management system 130 repeatedly (e.g., periodically) collects data from the storage system 120 and the CSP system 140 to store, concerning each of a plurality of time point s (e.g., a plurality of months), a value of each of the storage volume (T_{S}), the user used total volume (ΣU_{U}) (a total of one or more user used volumes (Uₙ) respectively corresponding to one or more service users), the lending total volume (ΣU_{T}) (a total of one or more lending volumes (U_{T}) respectively corresponding to one or more service users), and the actual used total volume (ΣU_{R}) (a total of one or more actual used volumes (U_{R}) respectively corresponding to one or more service users). A tendency of the data volume reduction effect is known from ΣU_{U} and ΣU_{R} at the plurality of time points. According to this embodiment, ΣU_{R} (or one or more U_{R}) is transmitted from the management system 130 to the CSP system 140. Therefore, the CSP manager can learn a tendency of the data volume reduction effect. Consequently, the CSP manager can easily determine, on the basis of the tendency, a lending volume to be increased without increasing T_{S}. Since a total capacity larger than T_{S} can be lent, it is likely that a capacity is depleted (ΣU_{R} reaches T_{S}). However, since a tendency of ΣU_{R} is known as explained above, it is possible to predict a period of the capacity depletion. It is possible to detect the likelihood of the capacity depletion according to the configuring of the one or more thresholds concerning ΣU_{R}.

This embodiment is explained in detail below.

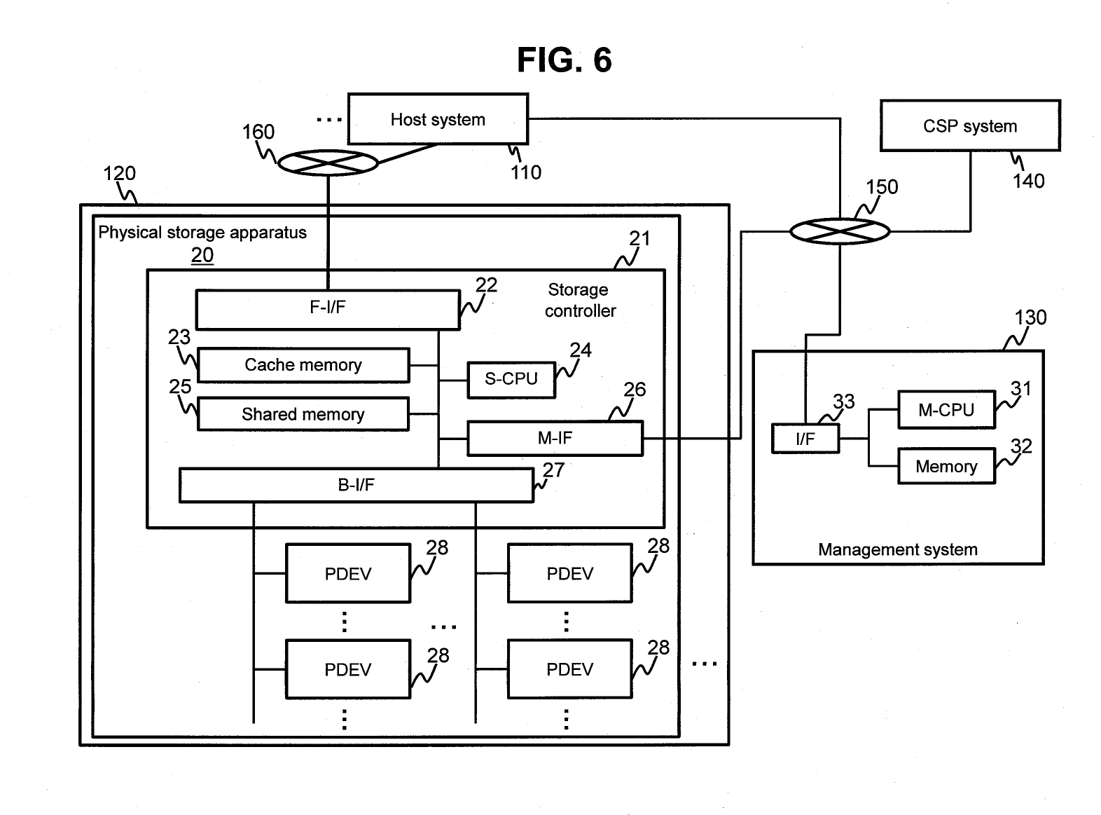

FIG. 6 shows an example of a hardware configuration of the information system according to the embodiment.

The storage system 120 includes one or more physical storage apparatus 20. The physical storage apparatus 20 includes a plurality of PDEVs 28 and a storage controller 21 coupled to the PDEVs 28. One or more RAID groups may be configured by the plurality of PDEVs 28.

The storage controller 21 includes a cache memory 23, a shared memory 25, an F-I/F (frontend interface device) 22, a B-I/F (backend interface device) 27, an M-I/F (management interface device) 26, and an S-CPU 24 coupled to the forgoing (“S-CPU” is an expression meaning a CPU in the storage controller 21).

The F-I/F 22 is an interface device coupled to the host system 110 through a first communication network. The B-I/F 27 is an interface device coupled to the PDEVs 28. The M-I/F 26 is an interface device coupled to the CSP system 140 and the management system 130 through a second communication network.

The cache memory 23 temporarily stores data input to and output from the PDEVs 28.

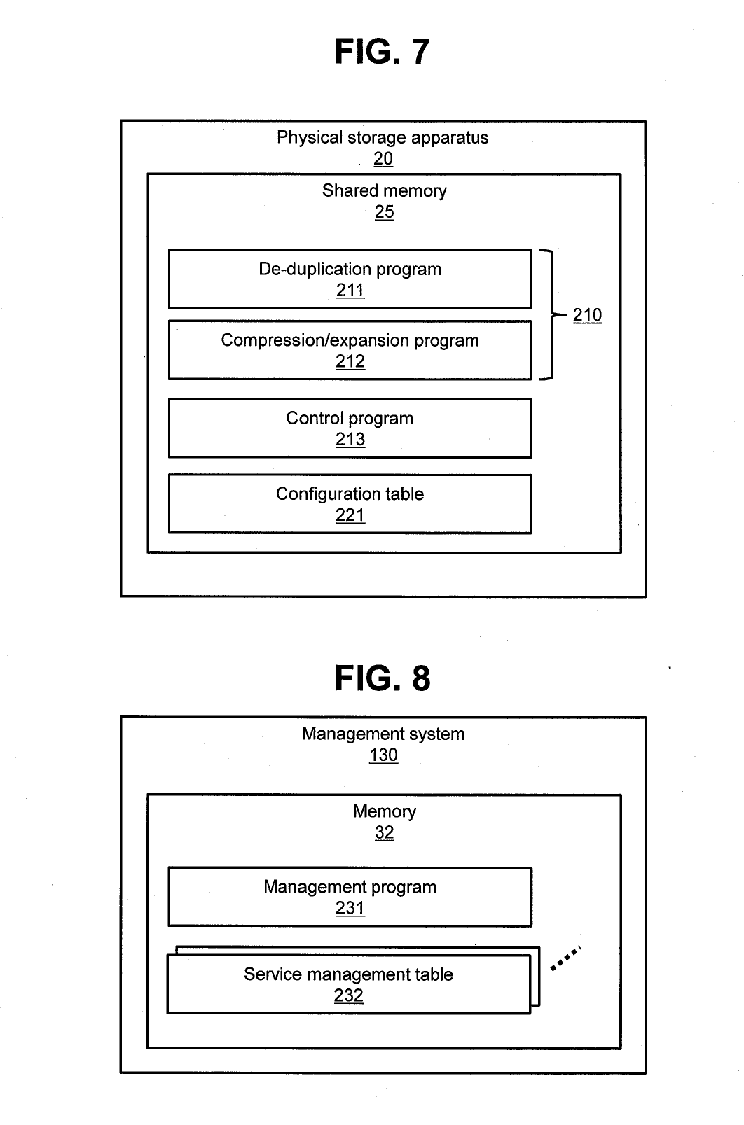

The shared memory 25 stores programs and information. For example, the shared memory 25 may store, as shown in FIG. 7, a de-duplication program 211 for performing a de-duplication process, a compression program 212 for performing a compression process (and an expansion process), and a control program 213 for performing other kinds of control. A function exhibited by the programs being executed by the S-CPU 24 is the data volume reduction function 210. However, the data volume reduction function 210 is not limited to this. The data volume reduction process such as the de-duplication process or the compression process may be performed by a hardware circuit instead of or in addition to being performed by the program being executed by the S-CPU 24 or may be performed by the PDEV 28 instead of or in addition to being performed by the storage controller 21. For example, the storage controller 21 may perform the de-duplication process by executing the program or with a hardware circuit. The PDEV 28 may perform the compression process by executing the program or with a hardware circuit. When the PDEV 28 performs the data volume reduction process such as the compression process or the de-duplication process, the PDEV 28 may notify a data volume after the data volume reduction process to the storage controller 21. The storage controller 21 may manage U_{R} of each VOL on the basis of the notified data volume.

The shared memory 25 may store a configuration table 221, which is a table including information concerning the configuration of the storage system 120. The configuration table 221 may include, for example, concerning each of one or more VOLs (storage spaces) respectively provided to one or more host systems 110, an ID of the VOL, an ID of the host system 110 to which the VOL is provided, a capacity (the lending volume U_{T}) of the VOL, the user used volume U_{U} of the VOL, the actual used volume U_{R} of the VOL, and a physical area address (e.g., an ID and an address of the PDEV 28) corresponding to the VOL. The configuration table 221 may include information representing a relation between a data volume and a data attribute (e.g., a data pattern or a file identifier) before and after the data volume reduction process.

The S-CPU 24 executes, for example, a computer program in the shared memory 25 to thereby perform processing for, for example, providing a VOL to the host system 110, identifying the PDEV 28 based on an address (e.g., an ID and an LBA (Logical Block Address) of the VOL) designated by an I/O (Input/Output) request from the host system 110, and performing I/O of data to and from the identified PDEV 28. The S-CPU 24 transmits information (e.g., ID, U_{T}, U_{U}, and U_{R} for each VOL) in the storage management information to the management system 130 in response to an inquiry from the management system 130 (or without the inquiry). As explained above, the S-CPU 24 performs the data volume reduction process such as the de-duplication process or the compression process. The S-CPU 24 may store, in the configuration table 221, the information representing the relation between the data volume and the data attribute (e.g., the data pattern or the file identifier) before and after the data volume reduction process.

The management system 130 includes an I/F (interface device) 33, a memory (an example of a storing unit) 32, and an M-CPU (an example of a processor) 31 coupled to the I/F 33 and the memory 32 (“M-CPU” is an expression meaning a CPU in the management system 130). The memory 32 stores programs and information. For example, as shown in FIG. 8, the memory 32 stores a management program 231 and a service management table 232. The management program 231 is executed by the M-CPU 31, whereby the management system 130 performs the processing explained above and processing explained below. The service management table 232 is an example of information included in management information retained by the management system 130. The service management table 232 is a management table of information concerning a cloud service and is present for each CSP.

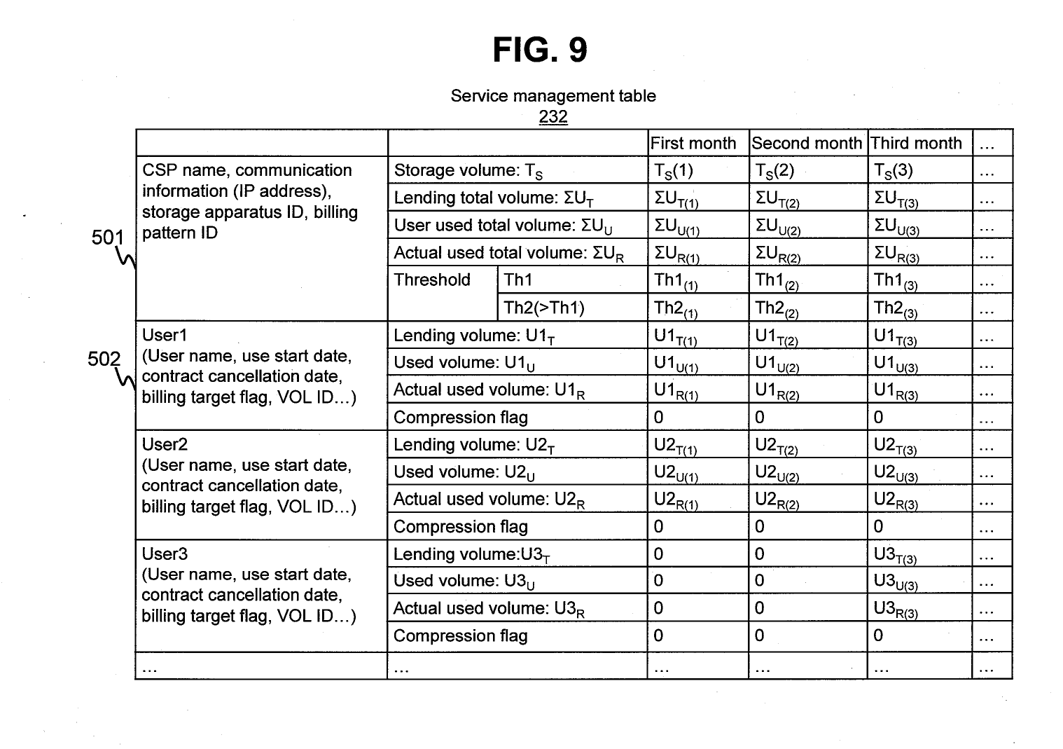

FIG. 9 shows an example of the configuration of the service management table 232.

The service management table 232 includes CSP information, user information of each service user, and a history of use states at a plurality of time points.

The CSP information is information concerning a CSP and includes, for example, a name of the CSP, information (e.g., an IP address) necessary for communication with the CSP system 140, an ID of the storage apparatus 121 purchased (or rent) by the CSP, and a billing pattern ID (see reference numeral 501). The billing pattern ID is an ID of an adopted billing pattern. Any one ID among billing pattern IDs “1”, “2”, “3-1”, “3-2”, “4-1”, and “4-2” is configured. The ID “1” corresponds to a pattern in which a base of an excess capacity amount is ΣU_{U} and a contracting user is not considered in billing amount calculation. The ID “2” corresponds to a pattern in which the base of the excess capacity amount is ΣU_{T} and a contracting user is not considered in billing amount calculation. The ID “3-1” corresponds to a pattern in which the base of the excess capacity amount is ΣU_{T}, a contracting user is considered in billing amount calculation, and re-stacking is not performed. The ID “3-2” corresponds to a pattern in which the base of the excess capacity amount is ΣU_{T}, a contracting user is considered in billing amount calculation, and re-stacking is performed. The ID “4-1” corresponds to a pattern in which the base of the excess capacity amount is ΣU_{U}, a contracting user is considered in billing amount calculation, and re-stacking is not performed. The ID “4-2” corresponds to a pattern in which the base of the excess capacity amount is ΣU_{U}, a contracting user is considered in billing amount calculation, and re-stacking is performed.

The user information of each service user is explained with reference to User 1, who is one service user, as an example. The user information of the User 1 is information concerning the User 1 and includes, for example, a name of the User 1, a use start date (a date when a capacity is lent to the User 1 for the first time (or a date when a contract is concluded with the User 1)), a contract cancellation date (a date when the User 1 cancels a use contract of a service (or a date when contract cancellation takes effect), a billing target flag (a flag indicating whether the User 1 is a billing target), and a VOL ID (an ID of a VOL provided to the host system 110 of the User 1) (see reference numeral 502).

The history of use states at the plurality of time points is, for example, use states in respective months to the present month after a contract between the storage vendor and the CSP takes effect. Concerning the CSP, the use states are respective values of T_{S}, ΣU_{T}, ΣU_{U}, ΣU_{R}, Th1, and Th2. As explained above, respective Th1 and Th2 are the thresholds compared with an actual use ratio ((ΣU_{R}/T_{S})*100%). Concerning the service user, the use states are respective values of T_{S}, U_{T}, U_{U}, U_{R}, and the compression flag. The compression flag is a flag indicating whether a compression function (execution of the compression program 212) is effective. T_{S}, ΣU_{T}, ΣU_{U}, ΣU_{R}, Th1, Th2, U_{T}, U_{U}, and U_{R} in a J-th month (J is an integer equal to or larger than 1) can be respectively represented as T_{S(J)}, ΣU_{T(J)}, ΣU_{U(J)}, ΣU_{T(J)}, Th1_{(J)}, Th2_{(J)}, U_{T(J)}, U_{U(J)}, and U_{R(J)}. According to the example explained above, the management system 130 can issue various arithmetic operation commands to the storage system 120, receive a result (T_{S(J)}, ΣU_{T(J)}, ΣU_{U(J)}, ΣU_{R(J)}, Th1_{(J)}, Th2_{(J)}, U_{T(J)}, U_{U(J)}, and U_{R(J)}) from the storage system 120, register the received result in corresponding columns in the service management table 232, and display information based on the received result. However, this is an example. For example, the management system 130 may receive U_{T(J)}, U_{U(J)}, U_{R(J)}, and the like of each service user, calculate ΣU_{T(J)}, ΣU_{U(J)}, ΣU_{R(J)}, and the like on the basis of the received information, register the calculated ΣU_{T(J)}, ΣU_{U(J)}, ΣU_{R(J)}, and the like in corresponding columns in the service management table 232, and display information based on the calculated ΣU_{T(J)}, ΣU_{U(J)}, ΣU_{R(J)}, and the like. Note that, in the following explanation, an expression such as “present aaa” (“aaa” is, for example, T_{S}, ΣU_{T}, ΣU_{U}, ΣU_{R}, Th1, Th2, U_{T}, U_{U}, or U_{R}) may be used. However, “aaa” may be a value acquired from a column corresponding to the present month (or the latest month) in the service management table 232 or may be a value represented by information received recently from at least one of the storage system 120 and the CSP system 140.

In this embodiment, the de-duplication function is default (i.e., always ON (effective)). The compression function is optional (i.e., selectively ON (effective)). In this embodiment, it is considered that there is at least one advantage below in the fact that the compression function is optional. (1) It is possible to suppress deterioration in read performance of a VOL provided according to provision of a cloud service of the CSP. This is because, unless data written in the VOL is not compressed, extension of data read out from the VOL is unnecessary. (2) Even if the actual use ratio exceeds at least one of Th1 and Th2, it is expected that an idle capacity is increased without increasing T_{S}. This is because a further data volume reduction can be expected if a compression flag corresponding to a non-compression user selected out of one or more non-compression users (one or more service users whose compression flags are OFF) is turned on, whereby data stored in a VOL corresponding to the selected non-compression user is compressed.

In this embodiment, since the compression flag is provided for each service user, the CSP manager can control ON/OFF of the compression flag for each service user. Therefore, the CSP can determine a billing amount to the service user on the basis of whether the compression flag of the service user is ON or OFF. That is, it can be expected that the billing amount to the service user by the CSP is made more reasonable. Therefore, an increase in service users entering into a contract with the CSP can also be expected. Since it can be expected that the billing amount to the service user by the CSP is made more reasonable, it can be expected that an excess capacity amount (at least a part of a billing amount to the CSP) calculated on the basis of a profit obtained by the CSP can also be made more reasonable. Note that, in this embodiment, the compression flag is prepared for each service user. However, the compression flag may be prepared in another unit such as for each VOL or each VOL portion (e.g., LBA range).

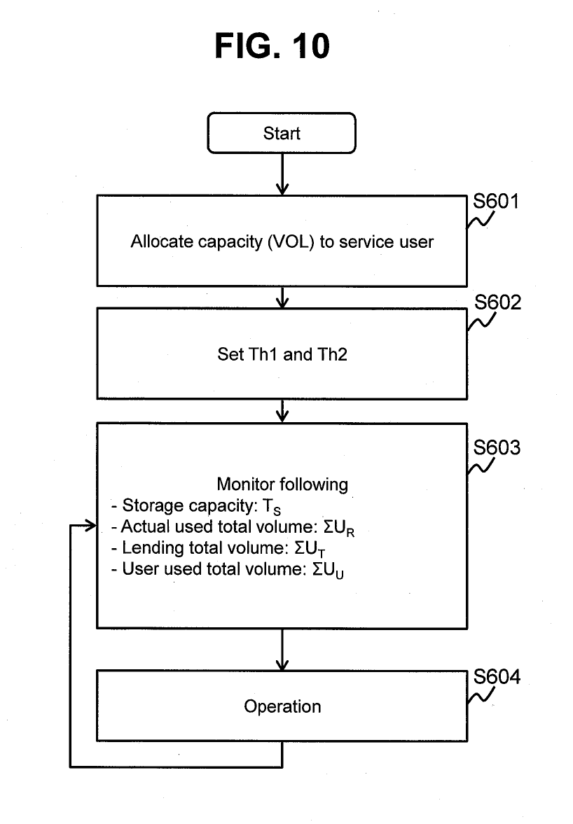

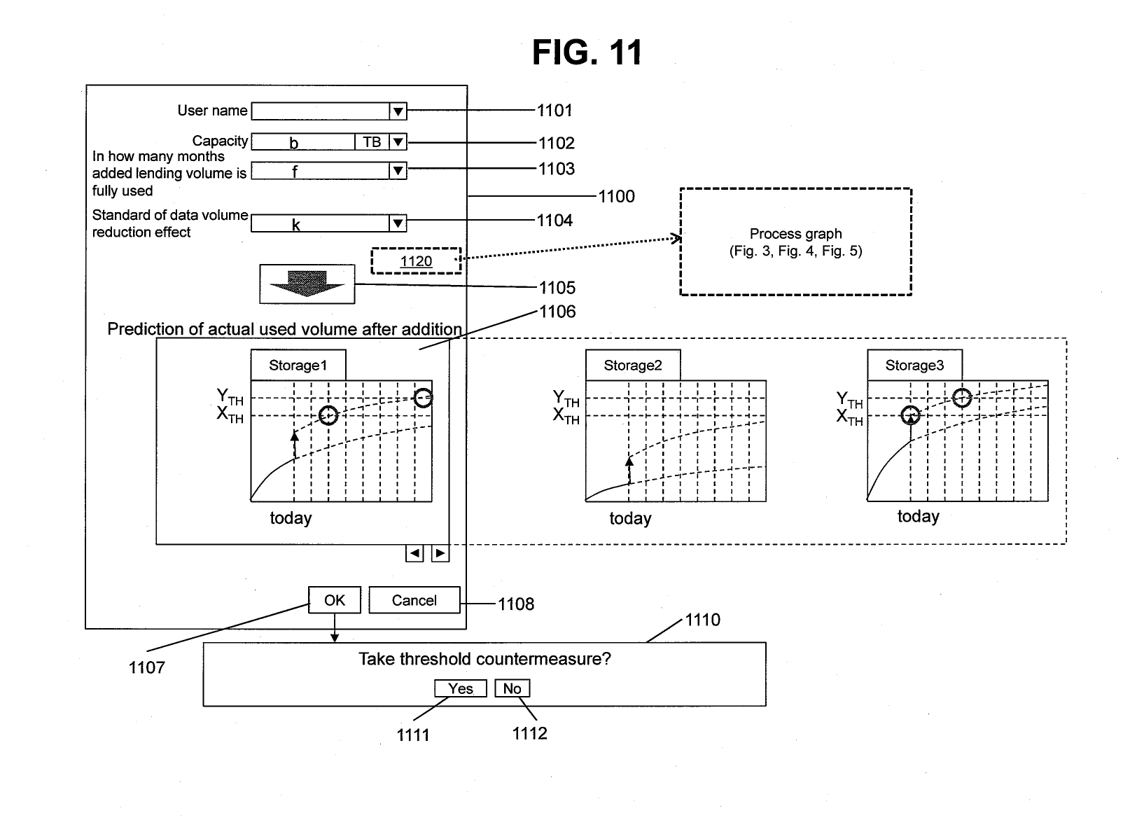

FIG. 10 shows an example of a flow including an operation start and a periodical data collection after the operation start. The flow is performed for each CSP. In the following example, one CSP is referred to as an example. Note that, when one CSP serving as the example is indicated, the CSP is hereinafter sometimes referred to as “target CSP”.

At the operation start, S601 and S602 are performed.

Specifically, in S601, the management program 231 receives designation of a lending volume for each service user from the CSP system 140. The management program 231 instructs, concerning the service users, the storage system 120 to provide a VOL (a storage space) having a designated lending capacity to the host systems 110 of the service users. Consequently, the VOL having the designated lending volume is provided from the storage apparatus 121 purchased by the CSP in the storage system 120 to the host systems 110 of the service users. The management program 231 registers, in the service management table 232 of the target CSP, concerning the service users, user information (user names, use start dates, contract cancellation dates, billing target flags, and IDs of provided VOLs). The management program 231 registers, in a column (e.g., a column corresponding to “first month”) of the service management table 232 of the target CSP, concerning the service users, “0” (OFF) as a compression flag.

Subsequently, in S602, the management program 231 receives input of Th1 and Th2 through, for example, a UI displayed on the CSP system 140 and registers the input Th1 and Th2 in the service management table 232 (e.g., a column corresponding to “first month”) of the target CSP. Th1 and Th2 may be registered in the storage system 120 and input from the storage system 120 instead of the CSP system 140.

After the operation start, data collection is periodically performed (S603 and S604). That is, the management program 231 periodically receives T_{S(J)}, ΣU_{T(J)}, ΣU_{U(J)}, ΣU_{R(J)}, Th1_{(J)}, Th2_{(J)}, U_{T(J)}, U_{U(J)}, and U_{R(J)} from at least one of the storage system 120 and the CSP system 140 and registers a result of the reception in corresponding columns in the service management table 232 of the target CSP.

After the operation start, the CSP can add a lending volume. The addition of a lending volume may be either addition of a further capacity to a lending volume to an existing service user and lending of a capacity to a new service user. The CSP can instruct the lending volume addition via a lending volume addition GUI (Graphical User Interface).

FIG. 11 shows an example of the lending volume addition GUI.

A lending volume addition GUI 1100 is displayed on the CSP system 140 by the management program 231 (or the CSP system 140). Information input to at least a part of the lending volume addition GUI 1100 is transmitted to the management program 231. Information displayed on at least a part of the lending volume addition GUI 1100 is information output by the management program 231.

The lending volume addition GUI 1100 includes a user name input UI 1101, a capacity input UI 1102, a user used volume input UI 1103, a reduction effect input UI 1104, a prediction instruction UI 1105, a prediction result display 1106, an addition execution UI 1107, and an addition cancellation UI 1108.

The user name input UI 1101 is a UI (e.g., a pull-down menu) for inputting a name of a provision destination user of a lending volume to be added. The capacity input UI 1102 is a UI (e.g., a pull-down menu) for inputting a lending volume (b) to be added. The user used volume input UI 1103 is a UI for inputting a standard of a user used volume of the provision destination user. Specifically, for example, a period (e.g., f months) in which the added lending volume is expected to be fully used is input to the user used volume input UI 1103. The reduction effect input UI 1104 is a UI for inputting a standard for a data volume reduction effect. As the standard for the data volume reduction effect, for example, a scaling factor may be used or a data attribute (e.g., a file identifier) may be used.

The prediction instruction UI 1105 is a UI (e.g., a button) for a prediction instruction, which is an instruction to predict an actual used total volume in future (after the lending volume addition) on the basis of information input to the UIs 1102 to 1104. The prediction result display 1106 is a UI (e.g., a window) for displaying a result of prediction performed in response to the prediction instruction. The management program 231 predicts, in response to the prediction instruction, a change (an increase volume) of an actual used total volume in a fixed period in future from the lending volume (b) input to the UI 1102, a period (f) input to the UI 1103, and a data volume reduction effect (k) identified on the basis of the information input to the UI 1104 and adds up the change and the present actual used volume ΣU_{R}. A result of the addition is a result of the prediction of the actual used total volume in the fixed period in future. Note that a used capacity (v) per a unit period (e.g., one month) may be input instead of the period (f) in which the added lending volume (b) is expected to be fully used. The management program 231 may calculate, on the basis of the used volume (v) per the unit period and the lending volume (b), the period (f) in which the lending volume (b) is expected to be fully used and predict, on the basis of the calculated period (f), a change (an increased volume) of the actual used total volume in the fixed period in future. In the service management table 232, details of the present ΣU_{R} (e.g., the present actual used volume of each storage apparatus 121 purchased by the target CSP) is registered. The management program 231 may predict, on the basis of the present actual used volume of each storage apparatus 121, an actual used volume in the fixed period in future for each storage apparatus 121 and display a result of the prediction on the prediction result display 1106. A first threshold (X_{TH}) and a second threshold (Y_{TH}) at present concerning the storage apparatuses 121 may be respectively the same value as Th1 and Th2 at the present. At least one of Th1 and Th2 may be different for each storage apparatus 121. The service management table 232 may be present, concerning one CSP, in each storage apparatus included in the CSP. X_{TH} and Y_{TH} may be respectively ratios to the capacity of the storage apparatus 121.

According to the example shown in FIG. 11, the CSP manager can determine that it is desirable to provide a storage space for the lending volume (b) from the storage apparatus 121 called Storage 2. Note that the management program 231 may acquire, from the storage system 120, detailed information (e.g., an apparatus state) of each storage apparatus 121 purchased by the target CSP, register the acquired detailed information in the service management table 232, and display detailed information of the storage apparatuses 121 on the lending volume addition GUI 1100. For example, when a state “apparatus being replaced” is displayed concerning the Storage 2, the CSP manager can also select lending of a capacity from the storage apparatus 121 other than the Storage 2.

In this way, the management program 231 (or the storage system 120 or the CSP system 140) predicts, on the basis of an input user used total volume change (e.g., a change calculated from (b) and (f) described above) and the input data volume reduction effect (k) (or (k) calculated from an input reduction effect attribute), a relation between an actual use ratio in future and at least one of Th1 and Th2, and displays the predicted relation. Consequently, the CSP manager can easily determine the lending volume (b). The prediction of the relation between the actual use ratio in future and at least one of Th1 and Th2 is performed for each storage apparatus 121 purchased by the CSP. Consequently, the CSP manager can easily select the storage apparatus 121 serving as a provision source of a VOL having the lending volume (b).

Note that, on the lending volume addition GUI 1100, a process graph shown in FIG. 3 to FIG. 5 (a graph indicating histories of at least ΣU_{U} and ΣU_{R} among T_{S}, ΣU_{T}, ΣU_{U}, ΣU_{R}, Th1, and Th2) or a UI 1120 for instructing display of the process graph may be displayed. Consequently, the CSP manager can easily determine the lending volume (b).

The addition cancellation UI 1108 is a UI (e.g., a “cancel” button) for cancelling the information input to the UIs 1101 to 1104. The addition execution UI 1107 is a UI (e.g., an “OK” button) for executing lending (providing) a capacity input to the capacity input UI 1102 to a user input to the user name input UI 1101. Note that, when the addition execution UI 1107 is pressed, the management program 231 displays a GUI (e.g., a dialog box) 1110 for inquiring whether a threshold countermeasure is taken. For example, when a storage apparatus in which an actual use ratio exceeds at least X_{TH} in a fixed period (ten months) or less from a reference date (e.g., today) is detected as a result of the prediction, the management program 231 may display, on the GUI 1110, an inquiry message based on an ID of the detected storage apparatus and a period when it is likely that the actual use ratio exceeds X_{TH} (e.g., “it is predicted that the actual use ratio reaches X_{TH} after two months in Storage 1. Do you want to take countermeasures against this at the present stage and put off excess of X_{TH}?”). When a No button 1112 on the GUI 1110 is pressed (when it is designated that the threshold countermeasure is unnecessary), the management program 231 executes lending of the lending volume (b) to the user without executing a threshold countermeasure flow. On the other hand, when a Yes button 1111 on the GUI 1110 is pressed (when it is designated that the threshold countermeasure is necessary), the management program 231 executes the threshold countermeasure flow and then executes lending of the lending volume (b) to the user.

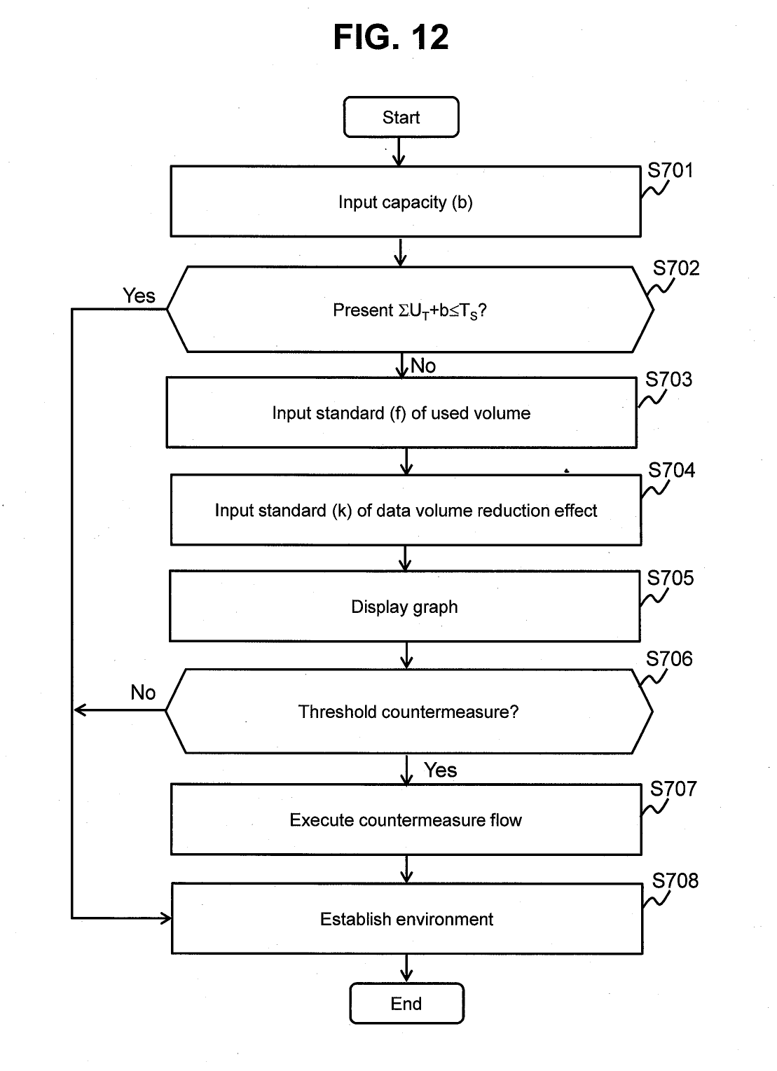

FIG. 12 shows an example of a lending volume addition flow.

The management program 231 receives input of the lending volume (b) (S701). The management program 231 determines whether a total of the lending volume (b) and the present ΣU_{T} is equal to or smaller than the present T_{S} (S702). If a result of the determination in S702 is affirmative (Yes in S702), the management program 231 instructs the storage system 120 to provide the VOL having the lending volume (b) to the host system 110 of the designated service user (S708).

If the determination result in S702 is negative (No in S702), the management program 231 receives the standard of the user used volume (the period in which the lending volume (b) is expected to be fully used) (f) (S703) and receives the standard (k) of the data volume reduction effect (S704). The management program 231 displays, on the basis of the lending volume (b), the standard (f) of the user used volume, the standard (k) of the data volume reduction effect, and the present ΣUR, a result of prediction (a graph) of an actual used total volume in the fixed period in future (S705).

If receiving the threshold countermeasure necessary designation (Yes in S706), the management program 231 executes at least one threshold countermeasure flow (S707) and then executes S708. On the other hand, if receiving the threshold countermeasure unnecessary designation (No in S706), the management program 231 executes S708 without S707.

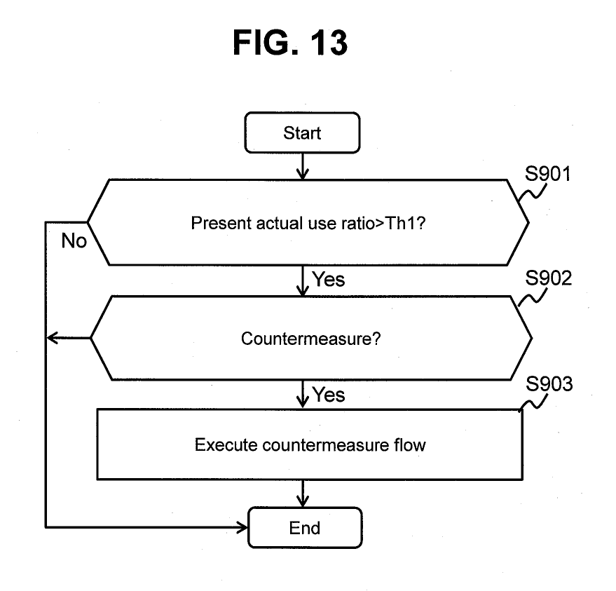

FIG. 13 shows an example of an overview of a threshold check flow. Note that the threshold check flow is equivalent to the threshold check function explained above. The threshold countermeasure flow is equivalent to the threshold countermeasure function explained above.

The threshold check flow may be started by the storage system 120 (the control program 213) with the data collection by the storage system 120 as an opportunity, may be started by the management program 231 with the data collection (S603 in FIG. 10) as an opportunity, or may be started with reception of a predetermined command from the CSP system 140 (the CSP manager) by the management program 231 as an opportunity. The management program 231 (or the storage system 120) determines whether the present actual use ratio (a ratio of the present ΣU_{R} to the present T_{S}) exceeds the present Th1 (S901). If a result of the determination in S901 is affirmative (Yes in S901), the management program 231 (or the storage system 120) determines whether a threshold countermeasure is taken (S902). The determination may be performed with reference to information such as a policy stored in a memory or the like in advance or may be performed by receiving the designation of the threshold countermeasure necessary/unnecessary from the CSP manager. IF the determination result in S902 is affirmative (Yes in S902), the management program 231 executes at least one threshold countermeasure flow (S903).

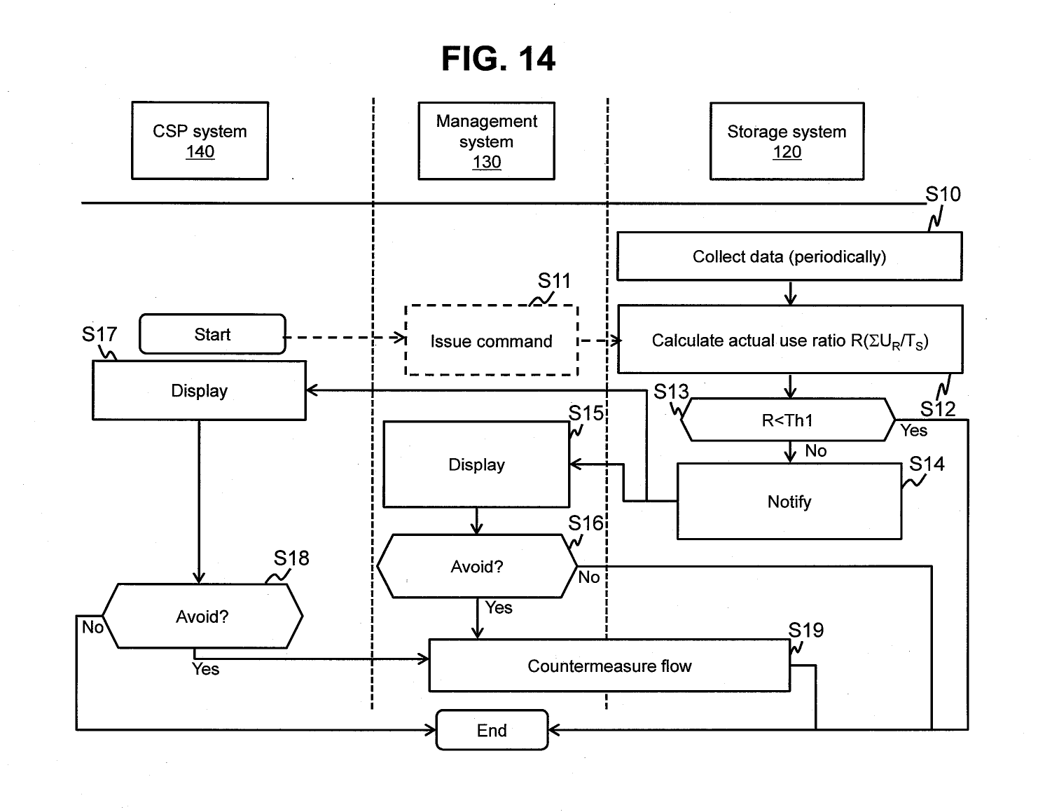

FIG. 14 shows an example of details of the threshold check flow.

According to this example, the storage system 120 (the control program 213) performs a threshold check. Specifically, the threshold check is as explained below.

That is, the storage system 120 periodically collects data (e.g., the present T_{S}, ΣU_{T}, ΣU_{U}, ΣU_{R}, Th1, and Th2) (S10). The storage system 120 calculates the present actual capacity ratio (=(present ΣU_{R}/present T_{S})*100) (S12) with the data collection as an opportunity or with a threshold check command from the management system 130 (the management program 231) as an opportunity (S11). Note that the threshold check command may be periodically issued by the management program 231 or may be issued in response to an instruction from the CSP manager (or the storage manager).

The storage system 120 determines whether the present actual capacity ratio is smaller than the present Th1 (S13). If a result of the determination in S13 is affirmative (Yes in S13), the processing ends.

If the determination result in S13 is negative (No in S13), the storage system 120 issues an alert (a notification) to at least one (in this example, both) of the management system 130 and the CSP system 140 (S14). The alert may be sent to the CSP system 140 through the management system 130.

The management system 130, which receives the alert (e.g., a message meaning the likelihood of capacity depletion), displays the alert (S15). If the management system 130 avoids the capacity depletion (Yes in S16), the management system executes the threshold countermeasure flow (S19). Note that the “case in which the capacity depletion is avoided” may be a case in which an instruction for the capacity depletion avoidance is received from the storage manager or may be a case in which there is a policy defining that the capacity depletion avoidance is performed if the alert issued because the present R is equal to or larger than the present Th1 is received.

The same processing may be performed also in the CSP system 140. That is, the CSP system 140, which receives the alert, displays the alert (S17). If the CSP system 140 avoids the capacity depletion (Yes in S18), the CSP system 140 instructs the management system 130 to execute the threshold countermeasure flow. The threshold countermeasure flow is executed in response to the instruction.

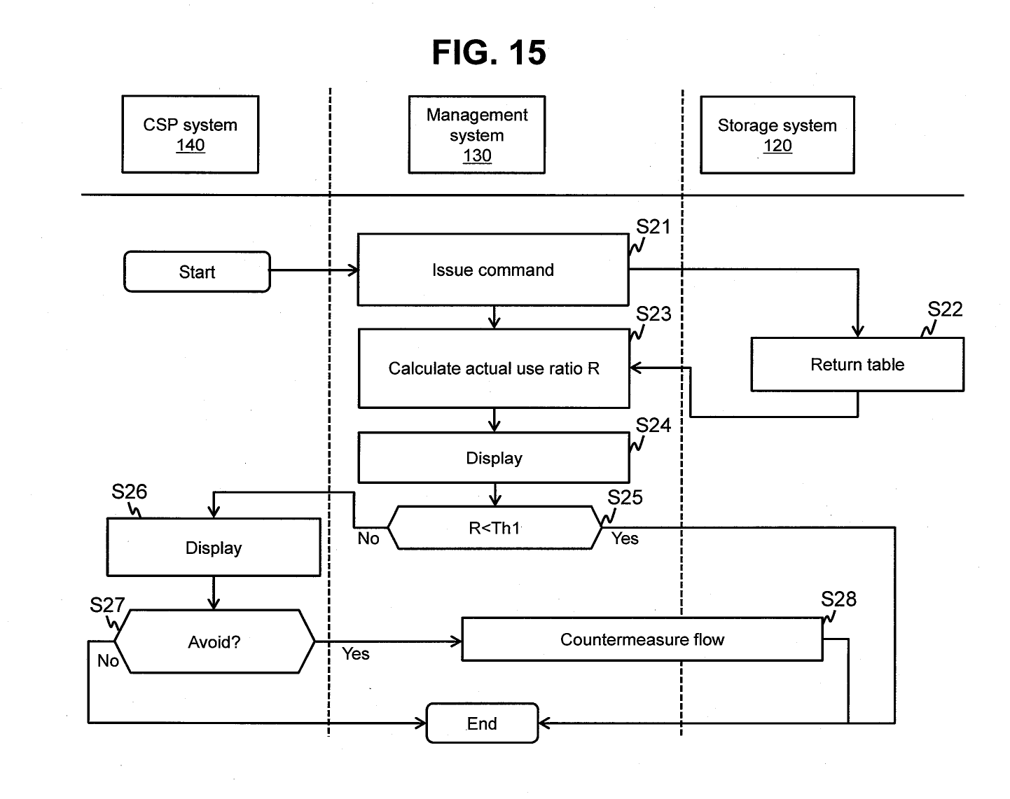

FIG. 15 shows another example of the details of the threshold check flow.

According to this example, the management system 130 (the management program 231) performs the threshold check. Specifically, the threshold check is as explained below.

The management system 130 (the management program 231) issues a data acquisition command to the storage system 120 (S21). The data acquisition command may be periodically issued by the management program 231 or may be issued in response to an instruction from the CSP manager (or the storage manager).

The storage system 120 transmits, in response to the data acquisition command, at least the present T_{S}, ΣU_{R}, and Th1 (e.g., all information of the table) of the service management table 232 to the management system 130 (S22).

The management program 231 calculates the present actual capacity ratio R (S23) and displays the present R and the present Th1 (S24).

If the present R is equal to or larger than the present Th1 (No in S25), the management program 231 displays an alert (e.g., a message meaning the likelihood of capacity depletion) on the CSP system 140 (S26). If the CSP system 140 avoid the capacity depletion (Yes in S27), the CSP system 140 instructs the management system 130 to execute the threshold countermeasure flow. The threshold countermeasure flow is executed in response to the instruction.

Several examples of the details of the threshold check flow are as explained above. Note that, in all the examples, the series of processing may be performed for each storage apparatus 121 purchased by the CSP. In that case, the “present actual capacity ratio R” in the explanation of FIG. 14 and FIG. 15 may be ((the present actual used total volume of the storage apparatus 121)/(the capacity of the storage apparatus 121))*100. The storage volume T_{S} may be a total of one or more capacities respectively corresponding to one or more storage apparatuses 121 purchased by the CSP. Th1 (and Th2) may be a ratio (%) to the capacity of the storage apparatus 121.

The threshold countermeasure flow is explained.

The threshold countermeasure flow is a flow of processing for reducing an actual use ratio of the storage system 120 (or the designated storage apparatus 121 alone). As the threshold countermeasure flow, there are a capacity addition flow, a migration flow, and a compression flow.

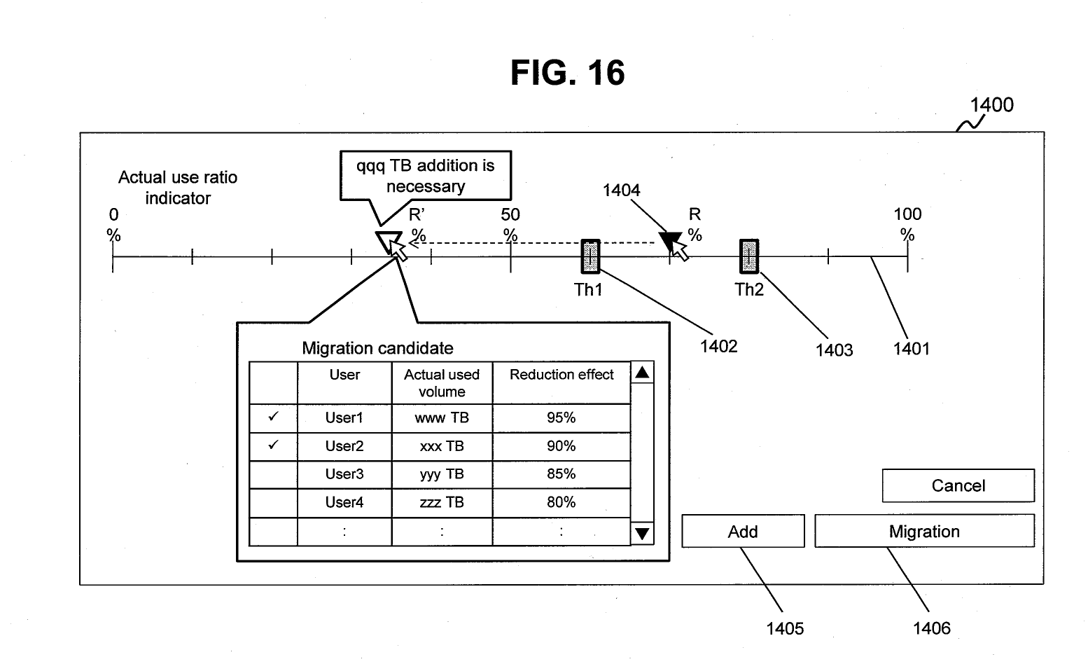

In at least one (in this example, both) of the capacity addition flow and the migration flow, for example, an addition/migration GUI 1400 shown in FIG. 16 is displayed. Capacity addition or migration is performed in response to an instruction input through the GUI 1400. The “capacity addition flow” is a flow for increasing the storage volume T_{S} (the capacity of the storage apparatus 121) to reduce the actual use ratio. As the addition of the capacity, for example, the PDEV 28 is added to any one of (or designated one of) the storage apparatuses 121 or the storage apparatus 121 is additionally purchased. The “migration flow” is a flow for migrating data from the designated storage apparatus 121 to another storage apparatus 121 to thereby reduce the actual use ratio of the designated storage apparatus 121.

The addition/migration GUI 1400 may be displayed on the management system 130 or the CSP system 140 by the management program 231. Therefore, input to (user operation on) the addition/migration GUI 1400 may be performed by the storage manager or the CSP manager. In the following explanation, when the CSP manager, the storage manager, and the like are not particularly distinguished, the CSP manager, the storage manager, and the like are sometimes simply referred to as “manager”.

According to the example shown in FIG. 16, a number line (an indicator) 1401 of the actual use ratio of the storage apparatus 121 is displayed on the addition/migration GUI 1400. A Th1 object 1402, which is an object representing the present Th1, is displayed (in a position corresponding to the present Th1) on the number line 1401. A Th2 object 1403, which is an object representing the present Th2 is displayed (in a position corresponding to the present Th2) on the number line 1401. An actual use object 1404, which is an object representing the present actual use ratio, is displayed (in a position corresponding to the present actual use ratio) on the number line 1401. At least one of the objects 1402 to 1404 is a slider (an example of a UI) movable along the number line 1401 by, for example, mouse drag.

In both of the capacity addition flow and the migration flow, the manager changes the position of the actual use object 1404 (or inputs a numerical value) to thereby input a desired actual use ratio to the addition/migration GUI 1400. The management program 231 displays an additional capacity and migration candidates in response to the input of the desired actual use ratio.

The display of the additional capacity is performed, for example, as explained below. That is, the management program 231 calculates, on the basis of an input actual use ratio R′ and the present storage volume T_{S} (or the present capacity of the storage apparatus 121), a capacity (the capacity of the PDEV 28 or the storage apparatus 121) W that has to be added. The calculated capacity W is calculated according to an equation (ΣU_{R}/(T_{S}+W))*100=R′. The management program 231 displays the calculated capacity. When the capacity addition is instructed (when an “add” button 1405 of the GUI 1400 is pressed by the manager), the management program 231 performs processing for adding the displayed capacity. The capacity addition flow is as explained above.

The display of migration candidates is performed, for example, as explained below. That is, the management program 231 selects one or more migration candidates on the basis of an input actual use ratio and displays the selected migration candidates. The “migration candidates” are VOLs that could be migration sources of data or targets (in this example, the service users) corresponding to the VOLs. In this embodiment, in particular, service users corresponding to a data volume reduction effect (U_{R}/U_{U}) equal to or larger than a predetermined value are displayed as the “migration candidates”. Migration candidates are selected by the management program 231 or the manager out of the one or more migration candidates (in FIG. 16, checkmarks mean the selected migration candidates). When the migration is instructed (when a “migration” button 1406 of the GUI 1400 is pressed), the management program 231 instructs the storage system 120 to migrate data corresponding to the selected migration candidates from the storage apparatus 121 (the storage apparatus 121 having an actual use ratio exceeding at least Th1) to another storage apparatus 121. The migration flow is explained above. Note that the data is migrated between the storage apparatuses 121, whereby the present actual use ratio of the storage apparatuses 121 decreases. When the number of migration candidates is zero or insufficient (when migratable data enough for realizing the input actual use ratio is absent), an additional capacity may be displayed instead of or in addition to the display of the migration candidates.

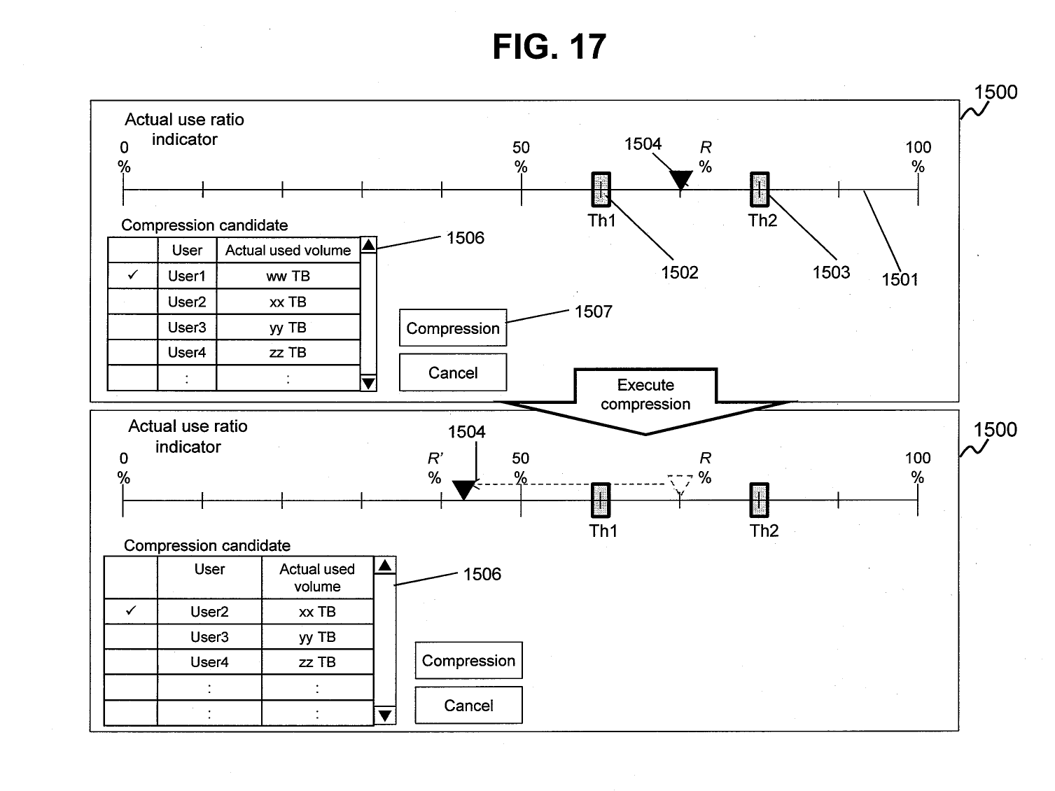

In the compression flow, for example, a compression GUI 1500 shown in FIG. 17 is displayed. The compression process is performed in response to an instruction input through the GUI 1500. The “compression flow” is a flow for compressing uncompressed data to reduce an actual use ratio. The compression GUI 1500 may be displayed on the management system 130 or the CSP system 140 by the management program 231.

According to the example shown in FIG. 17, a number line 1501 (an indicator) of an actual use ratio of the storage system 120 is displayed on the compression GUI 1500. As in FIG. 16, a Th1 object 1502, a Th2 object 1503, and an actual use object 1504 are displayed on the number line 1501. The actual use object 1504 is displayed in a position corresponding to the present ΣU_{R}. A list 1506 of service users corresponding to the compression flag “OFF” (service users identified by the management program 231 from the service management table 232) is displayed on the compression GUI 1500.

In the compression flow, for example, processing explained below is performed. That is, (C1) the manager selects a service user from the list (writes a checkmark) and instructs compression (presses a “compression” button 1507). (C2) The management program 231 identifies a VOL corresponding to the selected service user from the service management table 232 and transmits a compression instruction designating the identified VOL to the storage system 120. (C3) The storage system 120 compresses, in response to the compression instruction, data in the VOL designated in the compression instruction and returns ΣU_{R} after the compression (or a data volume after the compression concerning the VOL) to the management system 130. (C4) The management program 231 displays an actual use ratio after the compression (e.g., an actual use ratio calculated on the basis of ΣU_{R} after the compression (the returned ΣU_{R} or a value obtained by subtracting the returned data capacity from the present ΣU_{R}) on the compression GUI 1500 (e.g., moves an actual use object 1504 to a position corresponding to the actual use ratio after the compression). (C1) to (C4) explained above are repeated until an actual use ratio after the compression desired by the manager is obtained. Note that, if the actual use ratio after the compression desired by the manager is not obtained, a capacity addition flow (or migration flow) may be performed instead of the compression flow. The “ΣU_{R} after the compression (or the data volume after the compression concerning the VOL)” may be, instead of or in addition to the value after the data is actually compressed, an expected value in the case in which it is assumed that the data is compressed. The “expected value in the case in which it is assumed that the data is compressed” can be calculated by, for example, a method of either (1) or (2) explained below.

(1) The management program 231 receives input of a main application of a VOL (hereinafter, in this paragraph “designated VOL”) via an input screen (e.g., a GUI). The management program 231 identifies another VOL used for an application same as the input application (e.g., identifies another VOL referring to a management table representing a relation between VOLs and applications). The management program 231 calculates a predicted value of ΣU_{R} after compression (or a data volume after compression concerning the designated VOL) using a compression rate of the identified other VOL. Specific examples of the “application” include text data, image data, and database.
(2) The management program 231 calculates a predicted value of ΣU_{R} after compression (or a data volume after compression concerning the designated VOL) using an average of compression rates of VOLs on which compression is already executed (or an average of compression rates in a pool or in a storage system).

In both of the threshold countermeasure flows, a relation between the actual use ratio and at least one of Th1 and Th2 is displayed. At least one of a countermeasure process (e.g., capacity addition or migration) necessary for reducing the actual use ratio to a desired actual use ratio and an expected actual use ratio in the case in which an executable countermeasure process (e.g., compression) is executed is displayed. Consequently, the manager can determine to which degree the actual use ratio should be reduced or what kind of threshold countermeasure flow should be selected in order to reduce the actual use ratio.

It may be determined, for example, from the following viewpoint which threshold countermeasure flow among the capacity addition flow, the migration flow, and the compression flow should be selected. That is, the capacity addition (e.g., addition of the PDEV 28) cannot be performed unless there is a physical space. In the capacity addition, it is also sometimes necessary to add, anew, an enclosure on which the PDEV 28 can be mounted. In that case, a setting area is also necessary. The migration cannot be performed unless there is another storage apparatus 121 having an idle capacity enough for storing migration target data. On the other hand, the compression is performed in the storage apparatus 121. Therefore, usually, the physical space, the setting area, or the other storage apparatus 121 is not necessary. Therefore, it is possible to reduce the actual use ratio with the compression first and, thereafter, perform additional examination of the PDEV 28 or the storage apparatus 121 in preparation for threshold excess in future (in preparation for excess of at least Th1 by the actual use ratio). Note that there are various compression schemes (algorithms) for the compression. A compression scheme with a low compression rate may be preferentially adopted. A level of a compression rate is different depending on a data attribute (e.g., a data pattern). Therefore, the management program 231 may automatically learn a compression scheme with a high compression rate for each data attribute (e.g., accumulate a history of sets of date attributes, compression rates, and used compression schemes and from the history select a compression scheme with a highest compression rate concerning data attributes).

The threshold check and the countermeasures for the threshold check are as explained above.

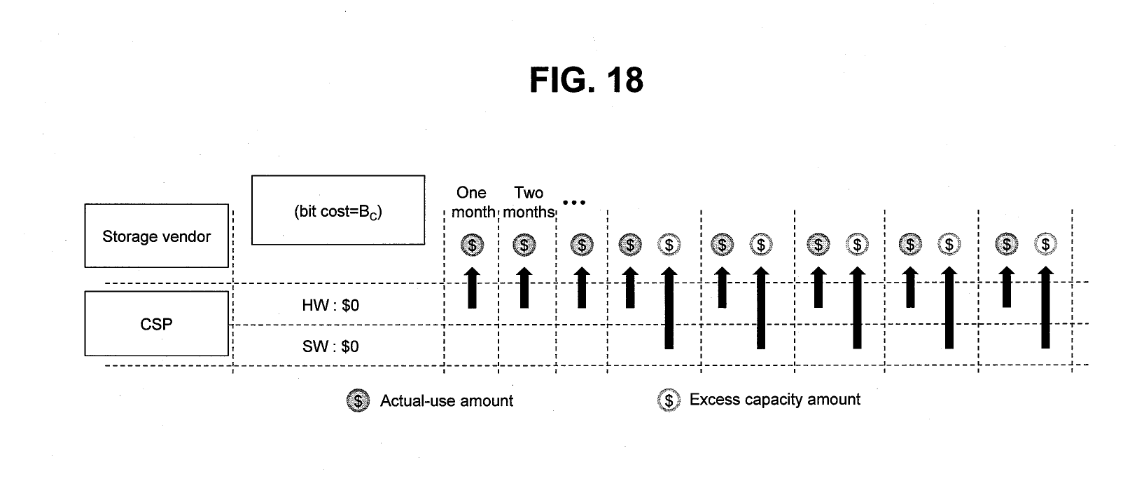

A billing amount calculation process is explained. Note that, in the above explanation, the CSP purchases the storage apparatus 121 and, thereafter, when at least one of ΣU_{U} and ΣU_{T} exceeds T_{S}, the excess capacity amount is billed. In the following explanation, the CSP purchases the storage apparatus 121 free of charge. Therefore, as shown in FIG. 18, a billing amount for the purchase of the storage apparatus 121 is calculated on the basis of the actual used total volume ΣU_{R}. In the following explanation, an amount calculated on the basis of ΣU_{R} is sometimes referred to as “actual-use amount”. When at least one of ΣU_{U} and ΣU_{T} exceeds T_{S}, both of the actual-use amount and the excess capacity amount are billed. At least one of the actual-use amount and the excess capacity amount is calculated on the basis of bit cost B_{C} (a price per unit capacity). B_{C} may be determined on the basis of, for example, a contract between the CSP and the storage vendor and may be different for each service user or may be the same value concerning all the service users of the CSP. In the former case, for example, a bit cost (B_{CU}) corresponding to the service user may be included in, for example, user information of each service user (user information registered in the service management table 232) (in this case, B_{C} may be, for example, an average of B_{CU} equal to or larger than 1). In the latter case, B_{C} may be included in the CSP information registered in the service management table 232. B_{C} may be an example of an element affecting a unit price. Note that, when the storage apparatus 121 is payed, the calculation of the actual-use amount may be skipped. Alternatively, even if the actual-use amount is calculated, the amount may be low compared with the case in which the storage apparatus 121 is free of charge. This only has to be flexibly determined on the basis of, for example, the contract between the CSP and the storage vendor.

In the above explanation, the excess capacity amount is calculated when at least one of ΣU_{U} and ΣU_{T} exceeds T_{S}. However, in the following explanation, it is previously determined on the basis of the contract between the CSP and the storage vendor which of ΣU_{U} and ΣU_{T} is compared with T_{S} (which of a time when ΣU_{U} exceeds T_{S} and a time when ΣU_{T} exceeds T_{S} is set as billing timing concerning the excess capacity amount).

The billing amount is repeatedly (e.g., periodically) calculated. In this embodiment, the billing amount calculation is performed every month. Each of T_{S(J)}, ΣU_{R(J)}, ΣU_{T(J)}, and ΣU_{U(J)} used in the billing amount calculation in the J-th month may be a value at a time point in a period belonging to the J-th month or may be a value (e.g., a maximum, a minimum, or an average) determined on the basis of a plurality of values respectively corresponding to a plurality of time points in the period belonging to the J-th month.

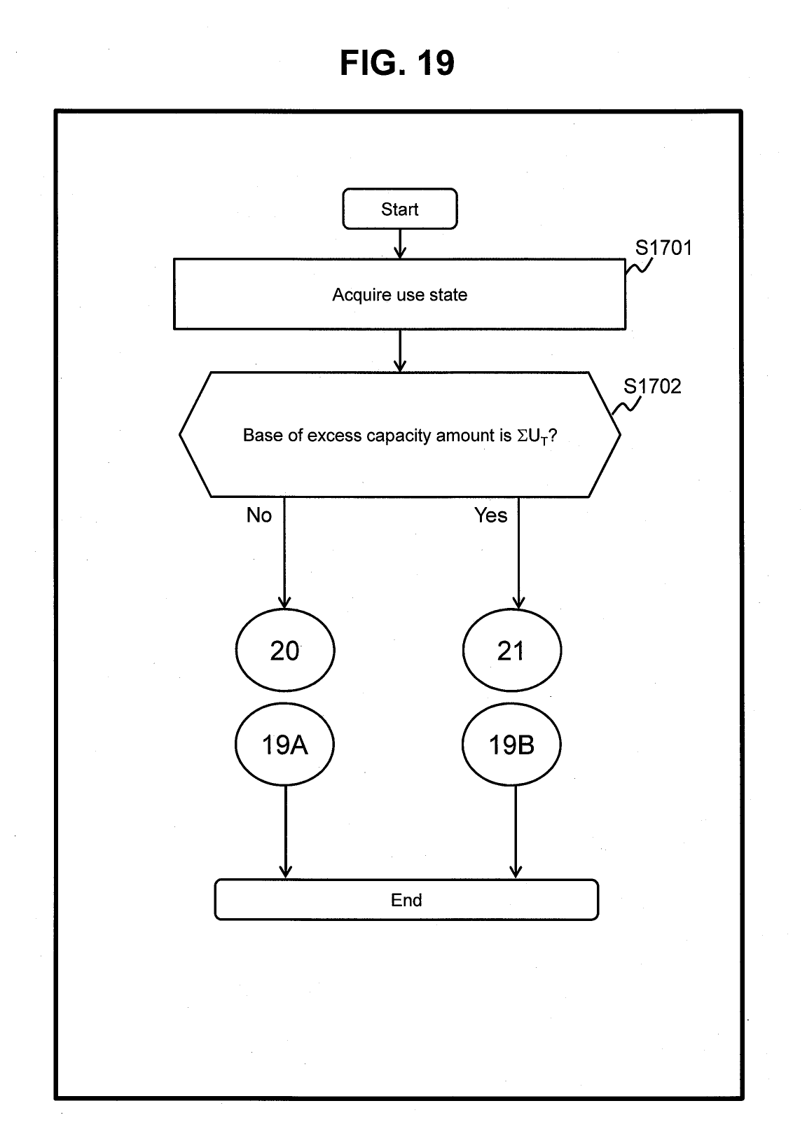

FIG. 19 to FIG. 21 show an example of a billing amount calculation flow. The billing amount calculation flow is started, for example, at a predetermined time period of a predetermined date every month. In the following explanation, the billing amount calculation flow started in the J-th month is explained as an example.

The management program 231 acquires a use state (S1701). The acquisition of the use state is acquisition of T_{S(J)}, ΣU_{R(J)}, ΣU_{T(J)}, and ΣU_{U(J)}. These values are acquired from the service management table 232 (or may be acquired from at least one of the storage system 120 and the CSP system 140 and registered in the service management table 232).

The management program 231 determines whether the base of the excess capacity amount is ΣU_{T} or ΣU_{U} (S1702). In other words, the management program 231 determines whether the billing timing is “excess of T_{S(J)} by ΣU_{T(J)}” or “excess of T_{S(J)} by ΣU_{U(J)}”. For example, the determination in S1702 is performed on the basis of a value of the billing pattern ID in the CSP information in the service management table 232.

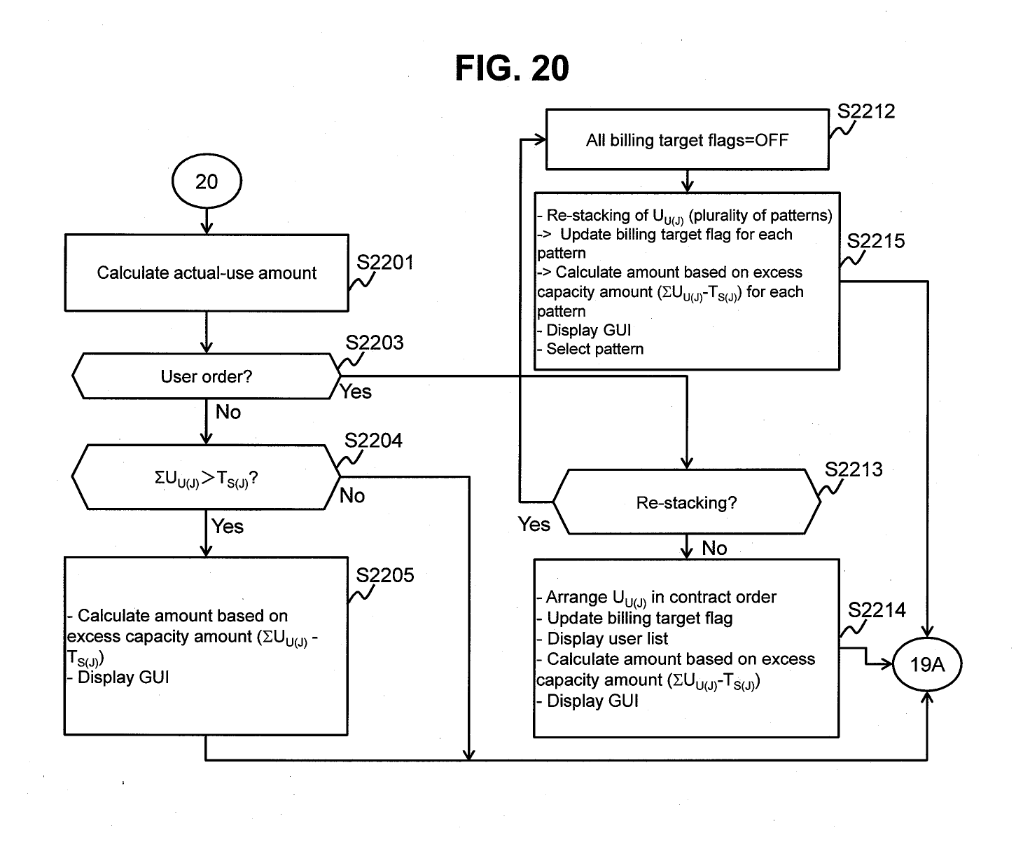

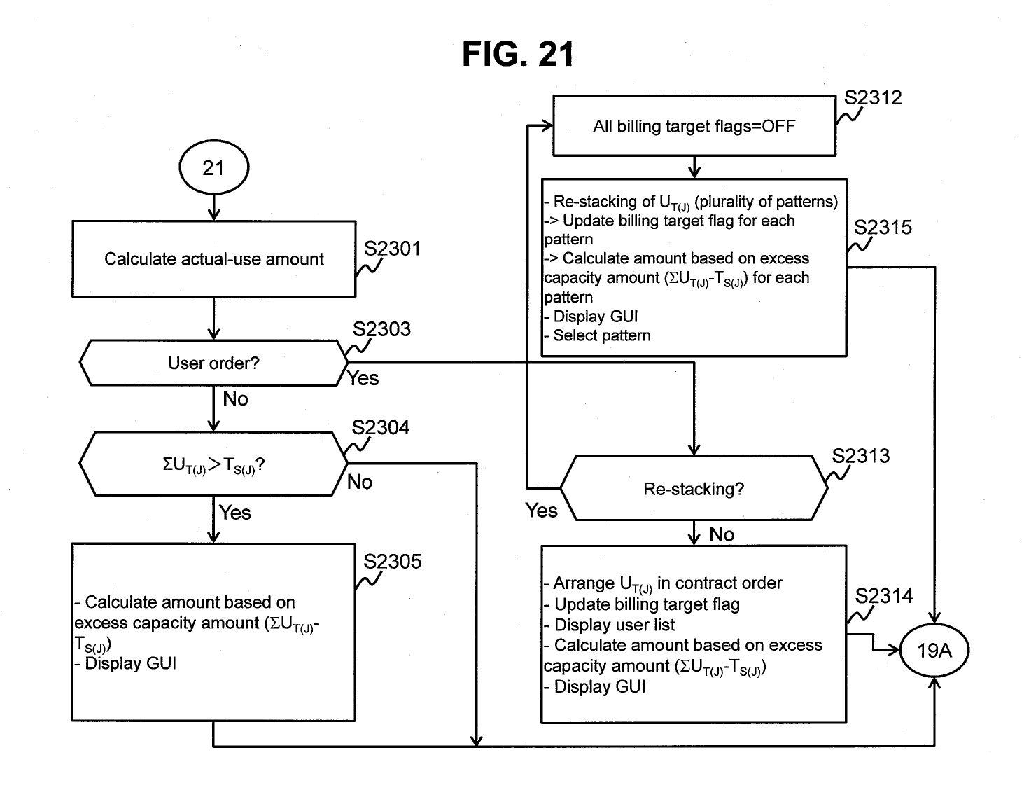

If the base of the excess capacity amount is ΣU_{U} (if the billing pattern ID is “1”, “4-1”, or “4-2”) (No in S1702), processing shown in FIG. 20 is performed. If the base of the excess capacity amount is ΣU_{T} (if the billing pattern ID is “2”, “3-1”, or “3-2”) (Yes in S1702), processing shown in FIG. 21 is performed.

It may be determined, for example, on the basis of the following viewpoints whether the base of the excess capacity amount is set as ΣU_{T} or ΣU_{U}.

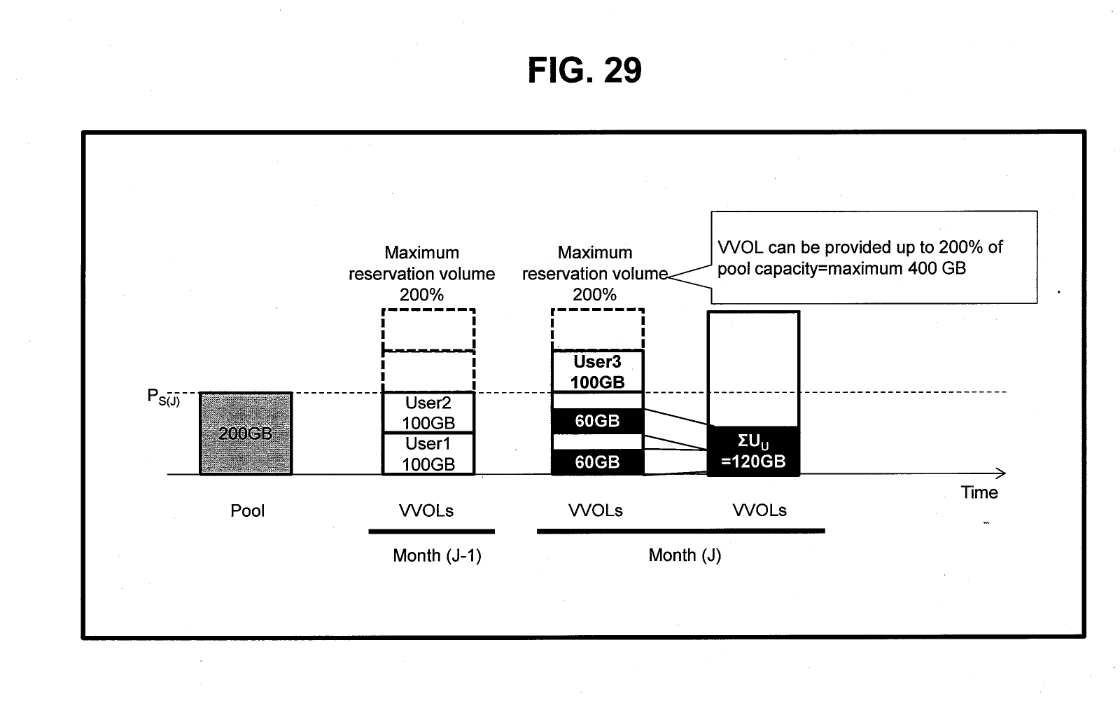

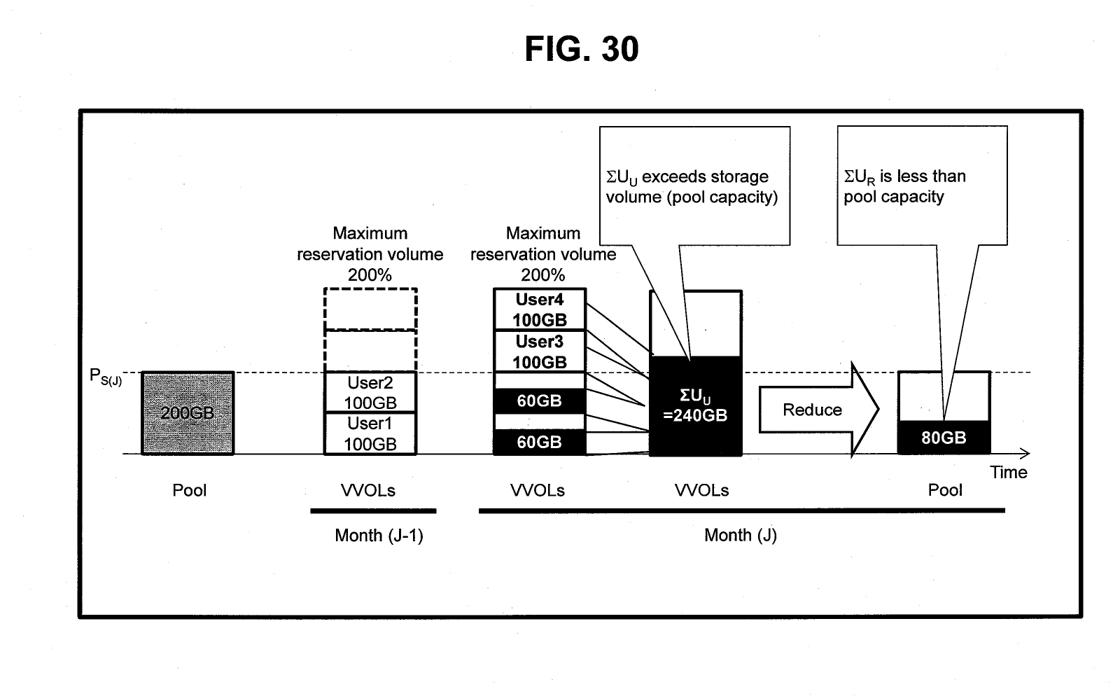

(Viewpoint 1) When the base of the excess capacity amount is ΣU_{T}, the excess capacity amount with respect to the CSP tends to be high compared with when the base of the excess capacity amount is ΣU_{U}. This is because, typically, ΣU_{T(J)} is larger than ΣU_{U(J)} and, therefore, (ΣU_{T(J)}−T_{S(J)}) is larger than (ΣU_{T(J)}−T_{S(J)}) (in some case, ΣU_{T}=ΣU_{U}). Therefore, when the base of the excess capacity amount is ΣU_{U}, the excess capacity amount with respect to the CSP tends to be low compared with when the base of the excess capacity amount is ΣU_{T}.
(Viewpoint 2) When the base of the excess capacity amount is ΣU_{T}, the CSP knows timing when the excess capacity amount is billed. This is because a lending capacity is a capacity determined by the CSP and, therefore, the CSP knows when ΣU_{T(J)} exceeds T_{S(J)}. On the other hand, when the base of the excess capacity amount is ΣU_{U}, the CSP does not know (less easily predicts) timing when the excess capacity amount is billed. This is because ΣU_{U(J)} is determined according to a volume of data stored by the services users and the CSP does not know (less easily predicts) when ΣU_{U(J)} exceeds T_{S(J)}.
(Viewpoint 3) If at least one VVOL is included in one or more VOLs provided to one or more service users, concerning at least the VVOL, the base of the excess capacity amount is ΣU_{U}, and ΣU_{T} is not adopted. This is because, concerning one pool, a total capacity of providable one or more VVOLs only has to be equal to or smaller than a maximum reservation Volume (a product of a capacity (PS) of the pool and a maximum reservation ratio (e.g., a value (%) larger than 100%)) and does not depend on the data reduction effect. Specifically, this is because, for example, as shown in FIG. 29, a capacity exceeding the pool capacity can be lent even if the data reduction effect is zero (absent). In other words, this is because, for example, as shown in FIG. 30, when ΣU_{U} exceeding P_{S} is reduced to the actual used total volume (ΣU_{R}) equal to or smaller than P_{S} by the data reduction function, the effect of the data reduction function is clear. Note that, concerning at least VVOL, the storage volume T_{S} is the capacity (P_{S}) of the pool. When there are a plurality of pools (e.g., a pool 1, a pool 2,), the pool capacity is present for each pool (P1_{S}, P2_{S},) A pool is associated with the VVOL. A real area is allocated to a virtual area of the VVOL from the pool associated with the VVOL.

FIG. 20 shows an example of a flow of processing performed when the base of the excess capacity amount is ΣU_{U}.

First, the management program 231 calculates an actual-use amount on the basis of ΣU_{T(J)} (S2201). The actual-use amount is, for example, B_{C}*(ΣU_{T(J)}−ΣU_{R}) and is 0 or more. That is, an actual-use amount in the J-th month is calculated on the basis of a difference between an actual used total volume up to the previous month and an actual used total volume of this month (the J-th month) and bit cost. The actual-use amount may be calculated by another method. For example, B_{C}*ΣU_{R(J)} may be calculated every month as the actual-use amount.

The management program 231 determines whether user order (arrangement order of contracting users) is taken into account for the calculation of the excess capacity amount (S2203). This determination is made, for example, on the basis of a value of the billing pattern ID in the CSP information in the service management table 232.

If a result of the determination in S2203 is negative (when the billing pattern ID is “1”) (No in S2203), the management program 231 determines whether ΣU_{U(J)} exceeds T_{S(J)} (S2204). If the determination result in S2204 is affirmative (Yes in S2204), the management program 231 performs at least one of the following kinds of processing (S2205-1) to (S2205-2) (S2205).

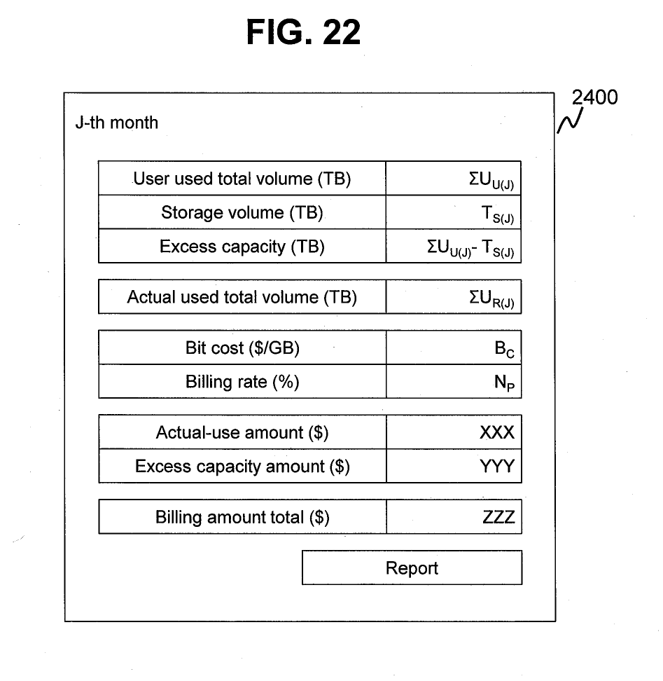

(S2205-1) The management program 231 calculates an excess capacity amount. The excess capacity amount is a value based on ΣU_{U(J)}−T_{S(J)} (e.g., a value based on (ΣU_{U(J)}−T_{S(J)}) and B_{C}). Specifically, for example, the excess capacity amount is (ΣU_{U(J)}−T_{S(J)})*B_{C}*N_{P}. N_{P} is a billing rate and may be, for example, 0<N_{P}<1. ΣU_{U(J)} is a total of U_{U(J)} of contracting service users.
(S2205-2) The management program 231 calculates a final billing amount using the calculated actual-use amount and the calculated excess capacity amount and displays a calculation result GUI 2400 indicating a result of the calculation. An example of the displayed calculation result GUI 2400 is shown in FIG. 22. The calculation result indicated by the calculation result GUI 2400 includes a billing amount total, details of the billing amount total (e.g., the actual-use amount and the excess capacity amount), and elements used for the billing amount calculation (e.g., at least one of T_{S(J)}, ΣU_{R(J)}, ΣU_{U(J)}, B_{C}, and N_{P}). When a “report” button on the GUI is pressed, the management program 231 may perform processing for issuing a bill of a billing amount displayed by the calculation result GUI 2400 and transmit a report describing display content of the calculation result GUI 2400 to a printing engine, another computer, or the like. Alternatively, the management program 231 may issue the report describing display content of the calculation result GUI 2400 to the CSP. The CSP may declare to the storage vendor that the CSP pays with the content of the report.

If the determination result in S2203 is affirmative (when the billing pattern ID is “4-1” or “4-2”) (Yes in S2203), the management program 231 determines whether re-stacking is performed (S2213). The “re-stacking” means changing arrangement order of U_{U(J)}. As default, the arrangement order is ascending order of use start dates (contract order) in user information.

If the determination result in S2213 is negative (when the billing pattern ID is “4-1”) (No in S2213), that is, when the re-stacking is not performed, the management program 231 performs at least one of the following kinds of processing (S2214-1) to (S2214-5) (S2214).

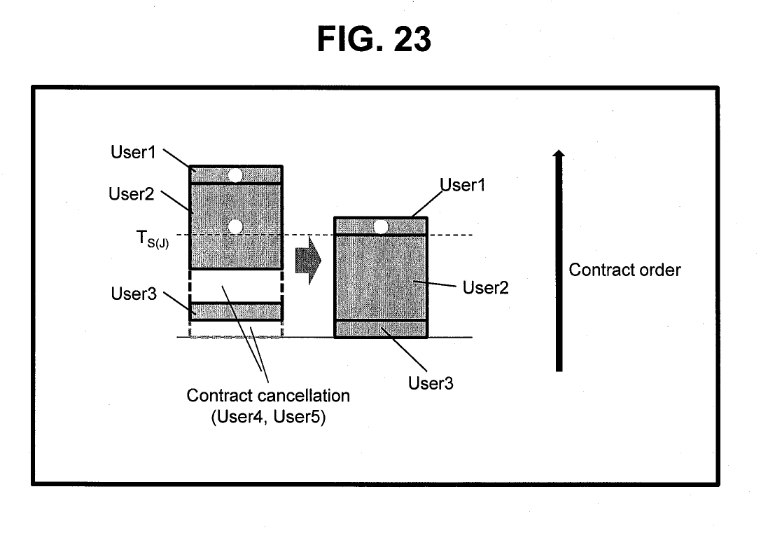

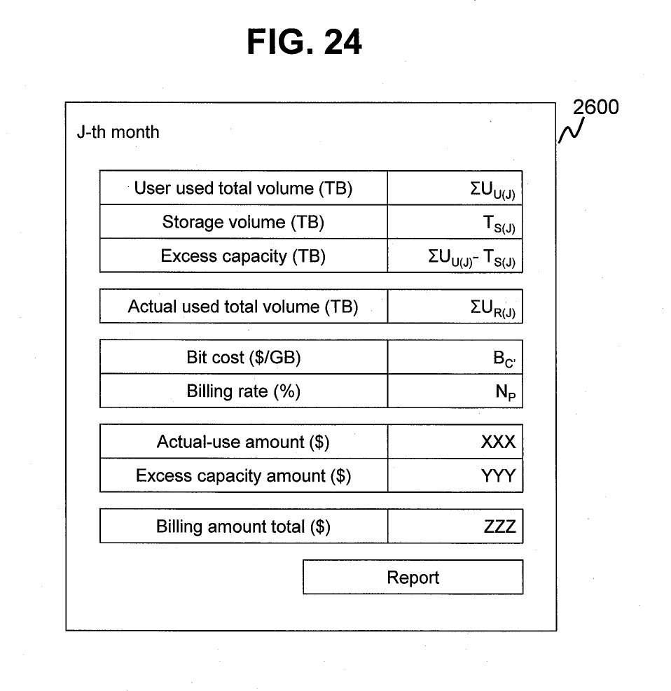

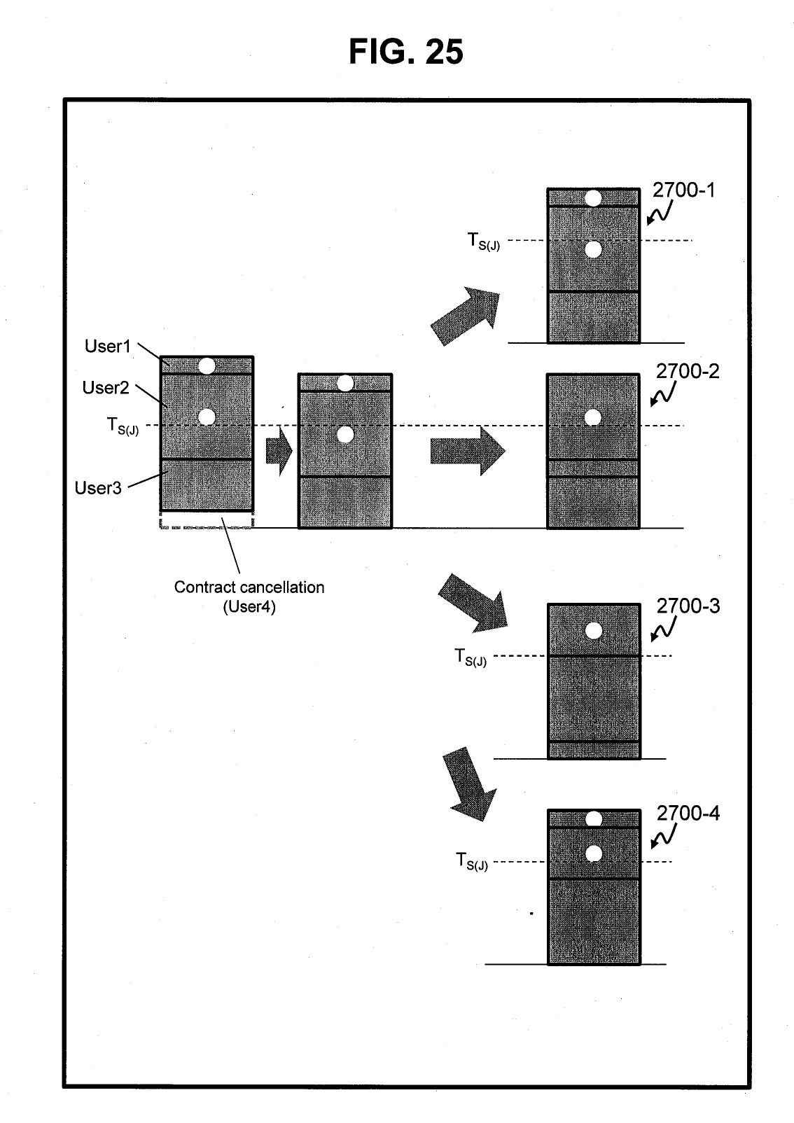

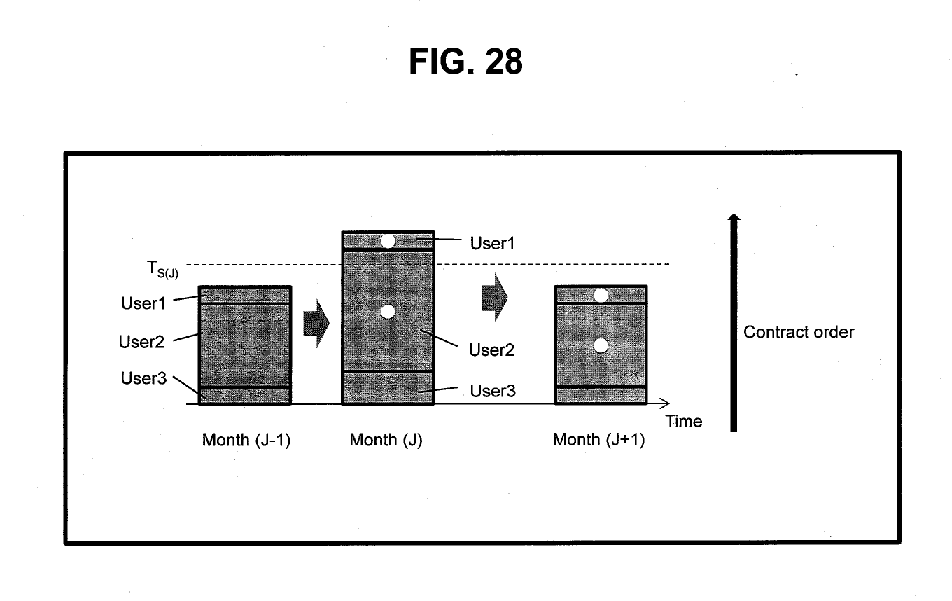

(S2214-1) The management program 231 arranges U_{U(J)} corresponding to the contracting service users in the contract order. Specifically, for example, the management program 231 determines, for each service user, from the present time point and a use start date and a contract cancellation date in user information corresponding to the service user, whether the service user has a contract (the contract is not cancelled after the conclusion of the contract). The management program 231 arranges U_{U(J)} in the contract order concerning the service user determined as having a contract.
(S2214-2) The management program 231 updates the billing target flag. The management program 231 determines whether ΣU_{U(J)}>T_{S(J)}. As shown in FIG. 28, the management program 231 turns “ON” only the billing target flag of the service user corresponding to a portion where ΣU_{U(J)} exceeds T_{S(J)} in Month(J). The “service user corresponding to a portion where ΣU_{U(J)} exceeds T_{S(J)}” means a service user corresponding to U_{U(J)} including at least a part of the portion where ΣU_{U(J)} exceeds T_{S(J)}. For example, in a state of Month(J) in FIG. 28, the User 1 and User 2 corresponding to boxes including white circles are service users set as billing targets. Note that, when a month changes from Month(J) to Month(J+1), the billing target flag of the service user whose ΣU_{U(J)} does not exceed T_{S(J)} is turned “OFF”.
(S2214-3) The management program 231 displays a list of service users whose billing target flags are “ON”. The list includes at least a part (e.g., a user name) of user information of the service users. In the list, the service users are arranged in the contract order.
(S2214-4) The management program 231 calculates an excess capacity amount. The excess capacity amount is a value based on ΣU_{U(J)}−T_{S(J)} (e.g., a value based on (ΣU_{U(J)}−T_{S(J)}) and B_{C}). Specifically, for example, the excess capacity amount is (ΣU_{U(J)}−T_{S(J)})*B_{C}*N_{P}. B_{C} is a value (e.g., an average) based on one or more bit costs (B_{CU}) respectively corresponding to one or more service users corresponding to portions where ΣU_{U(J)} exceeds T_{S(J)} in ΣU_{U(J)} (B_{C} may be equal to B_{C}). According to FIG. 23, before contract cancellation occurs, service users corresponding to portions where ΣU_{U(J)} exceeds T_{S(J)} are the User 1 and the User 2. However, as a result of (S2214-1) and (S2214-2) after the contract cancellation occurs, a service user corresponding to a portion where ΣU_{U(J)} exceeds T_{S(J)} is only the User 1. In FIG. 23 (and FIG. 25 referred to below), service users corresponding to boxes including white circles are service users set as billing targets. Note that, in the explanation of FIG. 23, the contract cancellation is explained as the example. However, a new contract (addition of a new service user) may occur instead of or in addition to the contract cancellation or an increase or a decrease in the used volume U_{U} of the contracting service user may occur (e.g., FIG. 28).
(S2214-5) The management program 231 calculates a final billing amount using the calculated actual-use amount and the calculated excess capacity amount and displays a calculation result GUI 2600 indicating a result of the calculation. An example of the displayed calculation result GUI 2600 is shown in FIG. 24. FIG. 24 may be different from FIG. 22 in that displayed bit cost could be B_{C} explained above. A user name and the like of the service user corresponding to portions where ΣU_{U(J)} exceeds T_{S(J)} may be displayed on the calculation result GUI 2600.

If the determination result in S2213 is affirmative (when the billing pattern ID is “4-2”) (Yes in S2213), that is, the re-stacking is performed, the management program 231 turns “OFF” billing target flags of all the service users (S2212). The management program 231 performs at least one of the following kinds of processing (S2215-1) to (S2215-3) (S2215)

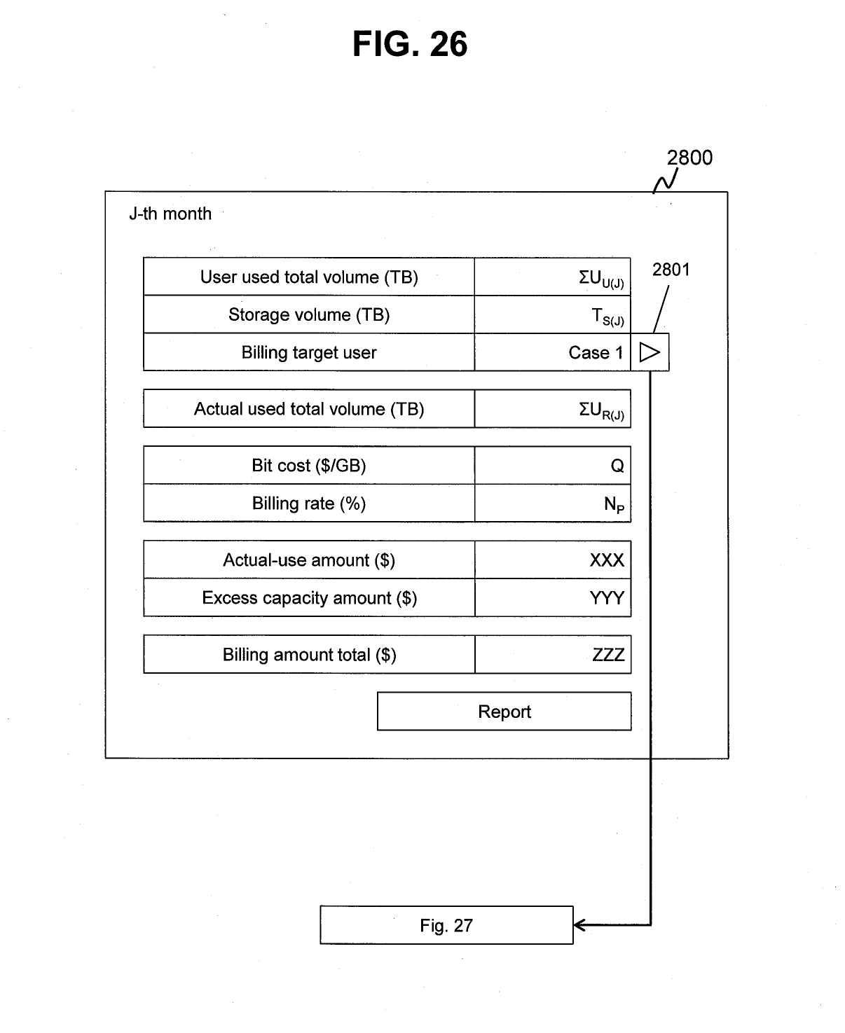

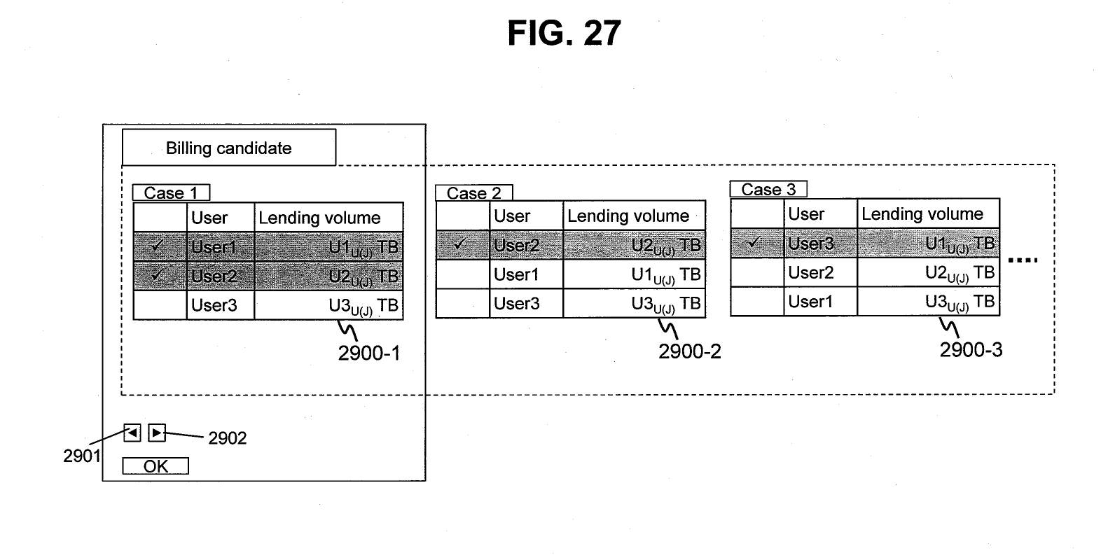

(S2215-1) The management program 231 determines whether ΣU_{U(J)}>T_{S(J)}.
(S2215-2) If a result of the determination in S2215-1 is affirmative, the management program 231 performs re-stacking (rearrangement) of U_{U(J)} of the contracting users. Consequently, typically, a plurality of patterns, that is, a plurality of kinds of arrangement (arrangement of U_{U(J)} are formed. According to the example shown in FIG. 25, four patterns 2700-1 to 2700-4 are formed. The management program 231 updates the billing target flag for each pattern (specifically, turns “ON” only the billing target flag of the service user corresponding to the portion where ΣU_{T(J)} exceeds T_{S(J)}). As a result, for example, according to the pattern 2700-3, the billing target user is only User 3. The management program 231 calculates an excess capacity amount for each pattern and calculates a final billing amount using the calculated actual-use amount and the calculated excess capacity amount. The excess capacity amount is a value based on ΣU_{U(J)}−T_{S(J)}. Specifically, for example, the excess capacity amount is (ΣU_{U(J)}−T_{S(J)})*Q*N_{P}. Q is a value (e.g., an average) based on one or more bit costs (B_{CU}) respectively corresponding to one or more billing target users (Q may be equal to B_{C}). Note that, as indicated by the flow of FIG. 20, the re-stacking (rearrangement) of U_{U(J)} is also performed when a new service user is added instead of or in addition to when the contract cancellation occurs.
(S2215-3) The management program 231 displays a calculation result GUI 2800 indicating a billing amount calculation result. An example of the displayed calculation result GUI 2800 is shown in FIG. 26. FIG. 26 is different from FIG. 24 in that a UI 2801 of a billing target user is provided and, by operating the UI 2801, as shown in FIG. 27, a user list for each pattern is displayed by the management program 231. In an example shown in FIG. 27, a displayed user list is a user list 2900-1 corresponding to one display target pattern “Case 1”. When a switching button 2901 or 2902 is pressed, a display target pattern is switched (user lists of all patterns may be displayed on one GUI). In a user list (2900-1, 2900-2, 2900-3,) for each pattern, U_{U(J)} is arranged according to arrangement order corresponding to the pattern. In the list, information concerning the billing target user (e.g., a row including a user name) is highlighted. In the user lists, B_{CU} of the service users may also be displayed. In the calculation result GUI 2800 (in at least one of FIG. 22, FIG. 24, and FIG. 26) or the user list for each pattern, a ground for a calculated billing amount is displayed. The ground may be at least one of information (e.g., bit cost (B_{C})) conforming to a contract between the storage vendor and the CSP and information (e.g., bit cost (B_{CU}) corresponding to the service user) conforming to a contract between the CSP and the service user. Consequently, in checking a billing amount, the CSP manager can check a part of contract content between the CSP and the storage vendor or the service user. The management program 231 finally displays a billing amount and the like corresponding to a pattern selected out of a plurality of patterns on the calculation result GUI 2800. The selected pattern may be a pattern manually selected by the CSP manager or may be a pattern automatically selected by the management program 231. The selected pattern may be a pattern corresponding to a lowest billing amount among a plurality of billing amounts respectively corresponding to the plurality of patterns. Consequently, it is considered that billing most reasonable for the CSP is performed. Note that a level of the billing amount corresponding to the pattern depends not only on the arrangement order of the service user (U_{U(J)}) but also on a unit price (the bit cost (B_{CU}) corresponding to the service user). The unit price may depend on priority and the like of the service user instead of or in addition to the bit cost (B_{CU}) corresponding to the service user.

FIG. 21 shows an example of a flow of processing performed when the base of the excess capacity amount is ΣU_{T}.

The flow shown in FIG. 21 is substantially the same as the flow shown in FIG. 20. Specifically, explanation of the flow shown in FIG. 21 is equivalent to the explanation of the flow shown in FIG. 20 in which “user used total volume (ΣU_{U(J)})” is read as “lending total volume (ΣU_{T(J)})”. Therefore, S2301 and S2303 to S2305 shown in FIG. 21 respectively correspond to S2201 and S2203 to S2205 in FIGS. 20. S2312 to S2315 in FIG. 21 respectively correspond to S2212 to S2215 in FIG. 20. However, there are differences in the following points.

(Difference 1) Concerning at least the VVOL, the base of the excess capacity amount is ΣU_{U}. ΣU_{T} is not adopted.
(Difference 2) S2314-2 corresponding to S2214-2 is, for example, as explained below. That is, the management program 231 determines whether ΣU_{T(J)}>T_{S(J)} and turns (ON) only a billing target flag of a service user corresponding to a portion where ΣU_{T(J)} exceeds T_{S(J)}. Even if a month changes and the entire U_{T} of the service user corresponding to the billing target flag “ON” moves to a portion where ΣU_{T(J)} does not exceed T_{S(J)}, the billing target flag is maintained “ON” (or may be turned “OFF”). The billing target flag of the service user whose ΣU_{T(J)} does not exceed T_{S(J)} is kept “ON” according to, for example, the following viewpoint. That is, when ΣU_{T(J)} is once larger than T_{S(J)}, this means that the CSP enjoys the advantage of the data volume reduction function 210 (one result of business expansion of the CSP). When the CSP enjoys such an advantage, irrespective of a subsequent change of ΣU_{T}, the service user corresponding to the portion where U_{T(J)} exceeds T_{S(J)} is maintained to be one element of an excess capacity amount based on the advantage enjoyed by the CSP through the data volume reduction function 210.

As explained above, concerning at least the VVOL, the base of the excess capacity amount is ΣU_{U}. ΣU_{T} is not adopted. When the VOL provided to the service user by the CSP is only the VVOL, concerning the CSP, for example, in FIG. 10 (the data collection), ΣU_{T} does not have to be collected. When the VOL provided to the service user by the CSP is only the VVOL, in the service management table shown in FIG. 9, a pool capacity (P_{S(J)}) of each pool may be adopted as an example of the storage volume (T_{S(J)}). Entries of the lending total volume and the lending volume may be absent. The billing pattern ID may be only an ID (“1”, “4-1”, or “4-2”) corresponding to ΣU_{U}. When the VOLs provided to the service user by the CSP are both of the RVOL and the VVOL, concerning the CSP, a service management table for the RVOL (e.g., the table shown in FIG. 9) and a service management table for the VVOL (e.g., a changed version of the table shown in FIG. 9 (e.g., the storage volume is changed to the pool capacity) may be prepared. In one service management table, the storage volume and details of the storage volume (e.g., a ratio of the pool capacity to the storage volume) may be managed.

The embodiment is explained above. However, the present invention is not limited to this embodiment. It goes without saying that the embodiment can be variously changed in a range not departing from the spirit of the present invention.

For example, the management program 231 may receive needs of the CSP manager, present selectable billing patterns, and receive selection of the presented billing patterns from the CSP manager. Specifically, for example, as the billing pattern ID, as explained above, there are “1”, “2”, “3-1”, “3-2”, “4-1”, and “4-2”. However, when receiving “provision of the VVOL” as the needs, the management program 231 may disable, concerning at least the VVOL, selection of the billing pattern IDs “2”, “3-1”, and “3-2” based on the lending total volume ΣU_{T} and present only “1”, “4-1”, and “4-2” as selectable billing pattern IDs.

### REFERENCE SIGNS LIST

110: host system, 120: storage system, 130: management system, 140: CSP (cloud service provider) system

1. A method of calculating a billing amount to a service provider in an environment in which a logical volume is provided from a storage system to a host system of a service user as a service of the service provider or for use of the service and a data volume reduction process is applied to data stored in the logical volume by a data volume reduction function, the method comprising:
(A) receiving first information and second information from at least one of a provider system and the storage system,
the first information being information for identifying at least one of a provided total capacity and a user used total volume,
the provided total capacity being a total capacity of one or more logical volumes provided to one or more service users,
the user used total volume is a total volume of one or more pieces of data before the data volume reduction process stored in the one or more logical volumes,
the second information being information for identifying a storage volume,
the storage volume being an upper limit of a capacity of a storage space that is held by the storage system concerning the service provider and in which data is stored, and
the provider system being a computer system of the service provider;
(B) determining, on the basis of the received first and second information, whether at least one of the user used total volume and the provided total capacity exceeds the storage volume; and
(C) calculating, when a result of the determination in (B) is affirmative, a billing amount based on at least one of a first excess capacity, which is a difference between the user used total volume and the storage volume, a second excess capacity, which is a difference between the provided total capacity and the storage capacity, and an amount corresponding to a service user defined as relating to at least one of the first and second excess capacities.

2. The method according to claim 1, further comprising:
(D) identifying a billing scheme selected concerning the service provider by referring to third information in which a billing scheme selected out of a plurality of billing schemes and the service provider are associated;
comparing, when the billing scheme identified in (D) includes a user used total volume base, the user used total volume with the storage volume in (B) and calculating the billing amount on the basis of at least one of the first excess capacity and the amount corresponding to the service user defined as relating to the first excess capacity in (C); and
comparing, when the billing scheme identified in (D) includes a provided total capacity base, the provided total capacity with the storage volume in (B) and calculating the billing amount on the basis of at least one of the second excess capacity and the amount corresponding to the service user defined as relating to the second excess capacity in (C).

3. The method according to claim 2, wherein
when the billing scheme identified in (D) includes being on a provided total capacity basis and fixing arrangement order of contracting service users, in a respective series of processing,
when the determination result in (B) is affirmative, the service user defined as relating to the second excess capacity is managed as a billing target user, and
even if the determination result in (B) is negative, when a service user managed as the billing target user is present, a billing amount including an amount concerning the service user is calculated.

4. The method according to claim 2, wherein
when the billing scheme identified in (D) includes being on a user used total volume basis and varying arrangement order of contracting service users, in a respective series of processing,
when the determination result in (B) is affirmative, a plurality of kinds of arrangement order of one or more user used volumes respectively corresponding to one or more contracting service users are identified,
by referring to fourth information in which a unit price based on an amount per a unit capacity is associate with each service user, one billing amount among a plurality of kinds of billing amounts respectively corresponding to the identified plurality of kinds of arrangement order is calculated, and each of the plurality of kinds of billing amounts is a billing amount based on a unit price corresponding to the service user relating to the first excess capacity in arrangement order corresponding to the billing amount, and
when the billing scheme identified in (D) includes being on a provided total capacity basis and varying the arrangement order of the contracting service users, in the respective series of processing,
when the determination result in (B) is affirmative, a plurality of kinds of arrangement order of one or more provided capacities respectively corresponding to one or more contracting service users are identified, and
by referring to the fourth information, one billing amount among a plurality of kinds of billing amount respectively corresponding to the identified plurality of kinds of arrangement order is calculated, and each of the plurality of kinds of billing amounts is a billing amount based on a unit price corresponding to the service user relating to the second excess capacity in arrangement order corresponding to the billing amount.

5. The method according to claim 2, further comprising, when the one or more logical volumes includes a virtual volume, which is a virtual logical volume to which a storage area is allocated from a pool in response to a write request from the host system, concerning at least the virtual volume, controlling selection of the provided total capacity base to be impossible as the billing scheme, wherein
concerning at least the virtual volume, the storage volume is a capacity of the pool.

6. The method according to claim 1, further comprising
managing, when the determination result in (B) is affirmative, the service user defined as relating to the first excess capacity as a billing target user, and
calculating, even if the determination result in (B) is negative, when a service user managed as the billing target user is present, a billing amount including an amount concerning the service user.

7. The method according to claim 1, further comprising
Identifying, when the determination result in (B) is affirmative, a plurality of kinds of arrangement order of one or more user used volumes or provided capacities respectively corresponding to one or more contracting service users; and
calculating, by referring to fourth information in which a unit price based on an amount per a unit capacity is associate with each service user, one billing amount among a plurality of kinds of billing amounts respectively corresponding to the identified plurality of kinds of arrangement order, each of the plurality of kinds of billing amounts being a billing amount based on a unit price corresponding to the service user relating to the first or second excess capacity in arrangement order corresponding to the billing amount.

8. The method according to claim 1, further comprising displaying billing result information, which is information including information indicating the determined billing amount and at least one ground for the billing amount, wherein
information indicating the ground for the determined billing amount is associated with the billing result information.

9. The method according to claim 1, further comprising:
identifying an actual used total volume conforming to a total volume of one or more pieces of data after the data volume reduction processing from the storage system; and
displaying (X) and (Y) described below,
(X) information indicating at least one of the actual used total volume and the user used total volume and a data volume reduction effect calculated on the basis of the user used total volume and the actual used total volume, and
(Y) an input UI (user interface) for at least one capacity of a capacity added to a capacity of a logical volume provided to an existing service user and a capacity of a logical volume provided to a new service user, wherein
the provided total capacity includes a capacity input through the input UI.

10. The method according to claim 1, further comprising:
identifying an actual used total volume conforming to a total volume of one or more pieces of data after the data volume reduction process from the storage system;
displaying a first input UI for a user used total volume change expected concerning an existing or new service user and a second input UI for an expected data volume reduction effect or an attribute affecting a data volume reduction effect; and
predicting a relation between a ratio of an actual used total volume in future to the storage volume and one or more thresholds of the ratio on the basis of the actual used total volume, a user used total volume change input through the first input UI, and a data volume reduction effect or an attribute input through the second input UI and displaying the predicted relation.

11. The method according to claim 10, further comprising predicting, for each storage device provided to the service provider among one or more storage devices included in the storage system, a relation between an actual used total volume in future and one or more thresholds concerning an actual used total volume on the basis of an actual used total volume in the storage device, the input user used volume, and the input data volume reduction effect or attribute.

12. The method according to claim 1, further comprising:
identifying an actual used total volume conforming to a total volume of one or more pieces of data after the data volume reduction process from the storage system;
displaying a relation between an actual use ratio, which is a ratio of the actual used total volume to the storage volume, and one or more thresholds of the actual use ratio; and
displaying at least one of a countermeasure process necessary for reducing the actual used ratio to an actual use ratio desired by the service provider and an expected actual use ratio in a case in which an executable countermeasure process is executed.

13. The method according to claim 12, wherein
the data volume reduction function includes a de-duplication function and a compression function,
the de-duplication function is a default function,
the compression function is a function optional for each service user, and
the expected actual use ratio is an actual use ratio expected in at least one case of a case in which data stored in a logical volume corresponding to a service user for whom the compression function is turned on is actually compressed and a case in which it is assumed that the data is compressed.

14. The method according to claim 1, wherein the storage system is a system manufactured by a storage vendor or sold, lent, or use-permitted to the service provider by the storage vendor.

15. A management system comprising:
a interface device coupled to provider system, which is a computer system of a service provider, and a storage system; and
a processor coupled to the interface device, wherein
the interface device is configured to receive first information and second information from at least one of the provider system and the storage system,
the first information is information for identifying at least one of a provided total capacity and a user used total volume,
the provided total capacity is a total capacity of one or more logical volumes provided to one or more service users,
the user used total volume is a total volume of one or more pieces of data before a data volume reduction process by a data volume reduction function stored in the one or more logical volumes,
the second information is information for identifying a storage volume,
the storage volume is an upper limit of a capacity of a storage space that is held by the storage system concerning the service provider and in which data is stored, and
the processor is configured to
determine whether at least one of the user used total volume and the provided total capacity identified from the first information exceeds the storage volume identified from the second information and,
when a result of the determination is affirmative, calculate a billing amount based on at least one of a first excess capacity, which is a difference between the user used total volume and the storage volume, a second excess capacity, which is a difference between the provided total capacity and the storage volume, and an amount corresponding to a service user defined as relating to at least one of the first and second excess capacities.
